(19) United States
(12) Patent Application Publication
(10) Pub. No.: US 2004/0077703 A1
(43) Pub. Date: Apr. 22, 2004

(54) Nodulisporic acid derivative spot-on formulations for combating parasites

(76) Inventors: Mark D. Soll, Alpharetta, GA (US); Albert Boeckh, Cumming, GA (US); Ronus De Bode, CV Velden (NL); Peter Johannes Servaas Savio Van Eijk, JM Weert (NL)

Correspondence Address: JUDY JARECKI-BLACK; PH.D., J.D., 3239 SATELLITE BLVD. 3RD FLOOR, DULUTH, GA, 30096, US

(21) Appl. No.: 10/618,975

(22) Filed: Jul. 14, 2003

Related U.S. Application Data
(60) Provisional application No. 60/415,627, filed on Oct. 2, 2002.

(51) Int. Cl. A01N 43/38

(52) U.S. Cl. 514/410

(57) ABSTRACT

This invention provides for, inter alia, spot-on compositions for the treatment or prophylaxis of parasite infestations in mammals or birds which comprise:

(1) at least one nodulisporic acid derivative;

(2) an acceptable liquid carrier vehicle; and

(3) optionally, a crystallization inhibitor.

The invention also provides for a method of treating parasitic infestations or for the prophylaxis of parasite infestations in mammals or birds which comprises topically applying to said mammal or bird an effective amount of a composition according to the present invention. Further, this invention relates to an amidation process to prepare amide derivatives of nodulisporic acid and to intermediate formed in this process.

### RELATED APPLICATIONS

This application claims priority to Provisional Application U.S. S No. 60/415,627 entitled “A Method for the Synthesis of Nodulisporamide” filed Oct. 2, 2002.

This application Reference is also made to copending application U.S. Ser. No. 10/279,356, filed Oct. 24, 2002, which in turn is a continuation-in-part of application U.S. Ser. No. 10/155,397, filed May 24, 2002, now pending, which in turn is a divisional of application Ser. No. 09/376,736, filed Aug. 17, 1999, now U.S. Pat. No. 6,426,333 issued on Jul. 30, 2002, which in turn is a continuation in-part of application U.S. Ser. No. 09/271,470, filed Mar. 17, 1999, now allowed, which in turn is a continuation-in-part of copending International Application PCT/FR97/01548 having an international filing date of Sep. 15, 1997, and designating the U.S. and claiming priority from French Application No. 96/11446, filed Sep. 19, 1996. Reference is also made to: U.S. application Ser. Nos. 10/052,597, filed Jan. 17, 2002, Ser. No. 10/120,691, filed Apr. 11, 2002, Ser. No. 08/719,942, filed Sep. 25, 1996, Ser. No. 08/692,430, filed Aug. 5, 1996, Ser. No. 08/863,182, filed May 27, 1997, Ser. No. 08/692,113, filed Aug. 5, 1996, Ser. No. 08/863,392, filed May 27, 1997, and Ser. No. 08/891,047, filed Jul. 10, 1997; French Application No. 97 03709, filed Mar. 26, 1997; and PCT/FR98/00601. All of the above-mentioned applications, as well as all documents cited therein, including parent applications if available, and documents referenced or cited in documents cited herein, are hereby incorporated herein by reference.

### FIELD OF THE INVENTION

This invention relates to inter alia spot-on formulations for combating parasites in birds and mammals. In particular, this invention provides for spot-on formulations comprising a composition comprising at least one nodulisporic acid derivative and a pharmaceutically or veterinary acceptable liquid carrier vehicle. This invention also provides for an improved method for eradicating, controlling, and preventing parasite infestation in birds and mammals. Further, this invention relates to an amidation process to prepare amide derivatives of nodulisporic acid and to intermediates formed in the process.

### BACKGROUND OF THE INVENTION

Animals such as mammals and birds are often susceptible to parasite infestations. These parasites may be ectoparasites, such as insects, and endoparasites such as filariae and worms.

Domesticated animal, such as cats and dogs, are often infested with one or more of the following ectoparasites:

cat and dog fleas (Ctenocephalides felis, Ctenocephalides sp. and the like),

ticks (R^{h}ipicephalus sp., Ixodes sp., Dermacentor sp., Amblyomma sp. and the like), and

mites (Demodex sp., Sarcoptes sp., Otodectes sp. and the like),

lice (Trichodectes sp., Cheyletiella sp., Lignonathus sp., and the like), and

flies (Hematobia sp., Musca sp., Stomoxys sp., Dermatobia sp., Coclyomia sp., and the like).

Fleas are a particular problem because not only do they adversely affect the health of the animal or human, but they also cause a great deal of psychological stress. Moreover, fleas are also vectors of pathogenic agents in animals, such as dog tapeworm (Dipylidium caninum), and humans.

Similarly, ticks are also harmful to the physical and psychological health of the animal or human. However, the most serious problem associated with ticks is that they are the vector of pathogenic agents, agents which cause diseases in both humans and animal. Major diseases which are caused by ticks include borreliosis (Lyme disease caused by Borrelia burgdorferi), babesiosis (or piroplasmosis caused by Babesia sp.) and rickettsiosis (also known as Rocky Mountain spotted fever). Ticks also release toxins which cause inflammation or paralysis in the host. Occasionally, these toxins are fatal to the host, such as in the case of the Australian paralysis tick, Ixodes holocyclus.

Moreover, mites and lice are particularly difficult to combat since there are very few active substances which act on these parasites and they require frequent treatment.

Likewise, farm animals are also susceptible to parasite infestations. For example, cattle are affected by a large number of parasites. Likewise, arthropod pests, such as flea, lice and ticks, infest poultry. A parasite, which is very prevalent among farm animals, is a tick genus Boophilus, especially those of the species microplus (cattle tick), decoloratus and anulatus. Ticks, such as Boophilus microplus, are particularly difficult to control because they live in the pasture where the farm animals graze. Other important parasites of cattle and sheep are listed as follows in order of decreasing importance:

myiases such as Dermatobia hominis (known as Berne in Brazil) and Cochlyomia hominivorax (greenbottle); sheep myiases such as Lucilia sericata, Lucilia cuprina (known as blowfly strike in Australia, New Zealand and South Africa). These are flies whose larva constitutes the animal parasite;

flies proper, namely those whose adult constitutes the parasite, such as Haematobia irritans (horn fly);

lice such as Linognathus vitulorum, etc.; and

mites such as Sarcoptes scabiei and Psoroptes ovis.

The above list is not exhaustive and other ectoparasites are well known in the art to be harmful to animals and humans. These include, for example migrating dipterous larvae.

Animals and humans also suffer from endoparasitical infections including, for example, helminthiasis, which is most frequently caused by a group of parasitic worms described as nematodes or roundworms. These parasites cause severe economic losses in pigs, sheep, horses, and cattle as well as affecting other domestic animals, such as dogs, cats and poultry. Other parasites which occur in the gastrointestinal tract of animals and humans include Ancylostoma, Anecator, Ascaris, Strongyloides, Trichinella, Capillaria, Toxocara, Toxascaris, Trichiris, Enterobius and parasites which are found in the blood or other tissues and organs such as filarial worms and the extra intestinal stages of Strogyloides, Toxocara and Trichinella.

Many insecticides exist in the art for treating parasites. These insecticides vary in their effectiveness to a particular parasite as well as their cost. However, the results of these insecticides is not always satisfactory because of, for example, the development of resistance by the parasite to the therapeutic agent, as is the case, for example, with carbamates, organophosphorus compounds and pyrethroids. Moreover, there is at the present time no truly effective method for controlling the set of parasites indicated above. Thus, there is a need in the art for more effective antiparasitic formulation treatment and protection of animal, e.g. mammals, fish and birds for a wide range of parasites. Moreover, there is a need in the art for an antiparasitic formulation which is easy to use on any type of domestic animal, irrespective of its size and the nature of its coat and which do not need to be sprinkled over the entire body of the mammal, fish or bird. Further, the formulation should be effective for a long period of time thereby reducing the number of times it has to be applied.

Compounds, which exhibit a degree of activity against a wide range ectoparasites, are known in the art. The arylpyrazoles as a class are known in the art and are described, for example, in copending applications U.S. Ser. No. 07/719,942; 08/933,016; 09/174,598; 08/863,182; and 08/863,692, as well as in U.S. Pat. No. 5,576,429; U.S. Pat. No. 5,122,530, EP-A-295,217, EP-A-352,944 and EP 295 177, the disclosures of which, as well as the references cited herein, are incorporated by reference. Reference is made to, for example, U.S. Pat. No. 5,567,429, U.S. Pat. No. 5,122,530, EP 295,117, and EP 846,686 A1 (or Banks GB 9,625,045, filed Nov. 30, 1996 also believed to be equivalent to U.S. Ser. No. 309,229, filed Nov. 17, 1997). This class of insecticides is known to possess excellent activity against insects, such as ticks and fleas. Fipronil is a 1-N-aryl pyrazole that is particularly effective against fleas and ticks

Other compounds parasiticides that are know in the art to be effective are those which possess a macrocyclic lactone ring. These compounds are particularly effective against ectoparasites, including lice, blowflies, flies, mosquitoes, mites, migrating dipterous larvae, and ticks, as well as endoparasites, such as nematodes and roundworms. Compounds of this group include avermectins, milbemycins, and derivatives of these compounds, for example, ivermectin or emamectin. Such substances are described, for example, in U.S. Pat. Nos. 3,950,360; 4,199,569; 4,879,749; and 5,268,710.

These compounds are well known to a person skilled in the art and are easily obtained either commercially or through techniques know in the art. Reference is made to the widely available technical and commercial literature. For avermectins, ivermectin and abamectin, reference may be made, for example, to the work “Ivermectin and Abamectin”, 1989, by M. H. Fischer and H. Mrozik, William C. Campbell, published by Springer Verlag., or Albers-Schönberg et al. (1981), “Avermectins Structure Determination”, J. Am. Chem. Soc., 103, 4216-4221. For doramectin, “Veterinary Parasitology”, vol. 49, No. 1, Jul. 5-15, 1993, may in particular be consulted. For milbemycins, reference may be made, inter alia, to Davies H. G. et al., 1986, “Avermectins and Milbemycins”, Nat. Prod. Rep., 3, 87-121, Mrozik H. et al., 1983, Synthesis of Milbemycins from Avermectins, Tetrahedron Lett., 24, 5333-5336, U.S. Pat. No. 4, 134, 973 and EP 677,054. These compounds are either natural products or are semi-synthetic derivatives thereof. The structure of these compounds is closely related, e.g., by sharing a complex 16-member macrocyclic lactone ring. The natural product avermectins are disclosed in U.S. Pat. No. 4,310,519 to Albers-Schönberg, et al., and the 22,23-dihydro avermectin compounds are disclosed in Chabala, et al., U.S. Pat. No. 4,199,569. Mention is also made of Kitano, U.S. Pat. No. 4,468,390, Beuvry et al., U.S. Pat. No. 5,824,653, European Patent Application 0 007 812 A1, published Jun. 2, 1980, U.K. Patent Specification 1 390 336, published Apr. 9, 1975, European Patent Application 0 002 916 A2, and Ancare New Zealand Patent No. 237 086, inter alia. Naturally occurring milbemycins are described in Aoki et al., U.S. Pat. No. 3,950,360 as well as in the various references cited in “The Merck Index” 12^{th} ed., S. Budavari, Ed., Merck & Co., Inc. Whitehouse Station, N.J. (1996). Semisynthetic derivatives of these classes of compounds are well known in the art and are described, for example, in U.S. Pat. No. 5,077,308, U.S. Pat. No. 4,859,657, U.S. Pat. No. 4,963,582, U.S. Pat. No. 4,855,317, U.S. Pat. No. 4,871,719, U.S. Pat. No. 4,874,749, U.S. Pat. No. 4,427,663, U.S. Pat. No. 4,310,519, U.S. Pat. No. 4,199,569, U.S. Pat. No. 5,055,596, U.S. Pat. No. 4,973,711, U.S. Pat. No. 4,978,677, U.S. Pat. No. 4,920,148 and EP 667 054.

Other classes of compounds include insect growth regulating (IGR) compounds, which either mimic juvenile hormones or the inhibit synthesis of chintin. IGR compounds that mimic juvenile hormones include, for example, azadirachtin, diofenolan, fenoxycarb, hydroprene, kinoprene, methoprene, pyriproxyfen, tetrahydroazadirachtin, and 4-chloro-2-(2-chloro-2-methyl-propyl)-5-(6-iodo-3-pyridylmethoxy)pyridizine-3(2H)-one. Chintin-synthesis inhibitors include, for example, chlorfluazuron, cyromazine, diflubenzuron, fluazuron, flucycloxuron, flufenoxuron, hexaflumuron, lufenuron, tebufenozide, teflubenzuron, triflumuron, 1-(2,6-difluorobenzoyl)-3-(2-fluoro-4-(trifluoromethyl)phenylurea, 1-(2,6-difluorobenzoyl)-3-(2-fluoro-4-(1,1,2,2-tetrafluoroethoxy)-phenylurea, and 1-(2,6-difluorobenzoyl) -3-(2-fluoro-4-trifluoro-methyl)phenylurea.

Another class of compounds, which are know in the art as potent endo- and ectoantiparasitic agents, are nodulisporic acid derivatives. These compounds are based upon three structures, A, B or C, which have the following structures:

nodulisporic acid (compound A)

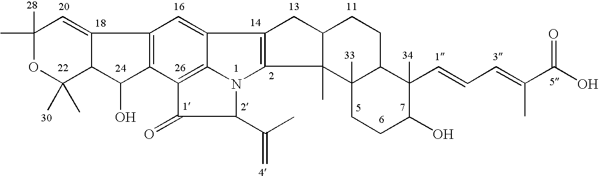

29,30-dihydro-20,30-oxa-nodulisporic acid (compound B)

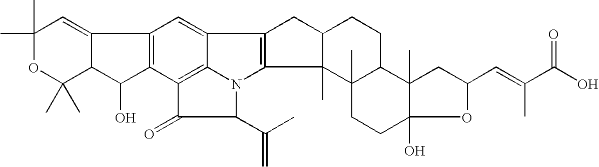

and

31-hydroxy-20,30-oxa-29,30,31,32-tetrahydro-nodulisporic acid (compound C)

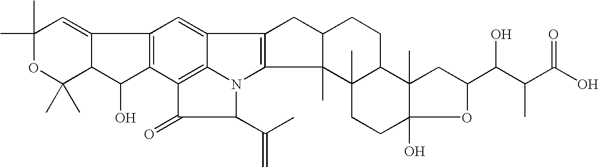

These compounds were obtained from the fermentation culture of Nodulisporium sp. MF-5954 (ATCC 74245) and the isolation and purification of the three nodulisporic acids are disclosed in U.S. Pat. No. 5,399,582. Derivatives of these compounds are described in WO 96/29073 and U.S. Pat. Nos. 5,945,317; 5,962,499; 5,834,260; 6,399,796; 6,221,894; 6,136,838; 5,595,991; and 5,614,546.

Nodulisporic acid derivatives possess potent activity against parasites, particularly helminths, ectoparasites, insects, and acarides, infecting man, animals and plants. These compounds have utility in human and animal health, agriculture and pest control in household and commercial areas.

The disease or group of diseases described generally as helminthiasis is due to infection of an animal host with parasitic worms known as helminths. Helminthiasis is a prevalent and serious economic problem in domesticated animals such as swine, sheep, horses, cattle, goats, dogs, cats, fish, buffalo, camels, llamas, reindeer, laboratory animals, furbearing animals, zoo animals and exotic species and poultry. Among the helminths, the group of worms described as nematodes causes widespread and often times serious infection in various species of animals. The most common genera of nematodes infecting the animals referred to above are Haemonchus, Trichostrongylus, Ostertagia, Nematodirus, Cooperia, Ascaris, Bunostomum, Oesophagostomum, Chabertia, Trichuris, Strongylus, Trichonema, Dictyocaulus, Capillaria, Habronema, Druschia, Heterakis, Toxocara, Ascaridia, Oxyuris, Ancylostoma, Uncinaria, Toxascaris and Parascaris. Certain of these, such as Nematodirus, Cooperia, and Oesophagostomum attack primarily the intestinal tract while others, such as Haemonchus and Ostertagia, are more prevalent in the stomach while still others such as Dictyocaulus are found in the lungs. Still other parasites may be located in other tissues and organs of the body such as the heart and blood vessels, subcutaneous and lymphatic tissue and the like. The parasitic infections The parasitic infections known as helminthiases lead to anemia, malnutrition, weakness, weight loss, severe damage to the walls of the intestinal tract and other tissues and organs and, if left untreated, may result in death of the infected host. The compounds of this invention have activity against these parasites, and in addition are also active against Dirofilaria in dogs and cats, Nematospiroides, Syphacia, Aspiculuris in rodents, arthropod ectoparasites of animals and birds such as ticks, mites such as scabies lice, fleas, blowflies, and other biting insects in domesticated animals and poultry, such as Tenophalides, Ixodes, Psoroptes, and Hemotobia, in sheep Lucilia sp., biting insects and such migrating dipterous larvae as Hypoderma sp. in cattle, Gasterophilus in horses, and Cuterebra sp. in rodents and nuisance flies including blood feeding flies and filth flies.

Nodulisporic acid derivatives are also useful against parasites which infect mammals, such as cats, dogs and humans. The most common genera of parasites of the gastrointestinal tract of man are Ancylostoma, Necator, Ascaris, Strongyloides, Trichinella, Capillaria, Trichuris, and Enterobius. Other medically important genera of parasites which are found in the blood or other tissues and organs outside the gastrointestinal tract are the filiarial worms such as Wuchereria, Brugia, Onchocerca and Loa, Dracunuculus and extra intestinal stages of the intestinal worms Strongyloides and Trichinella. The compounds are also of value against arthropods parasitizing man, biting insects and other dipterous pests causing annoyance to man.

Nodulisporic acid derivatives are also active against household pests such as the cockroach, Blatella sp., clothes moth, Tineola sp., carpet beetle, Attagenus sp., the housefly Musca domestica as well as fleas, house dust mites, termites and ants.

Nodulisporic acid derivatives are also useful against insect pests of stored grains such as Tribolium sp., Tenebrio sp. and of agricultural plants such as aphids, (Acyrthiosiphon sp.); against migratory orthopterans such as locusts and immature stages of insects living on plant tissue. The compounds are useful as a nematocide for the control of soil nematodes and plant parasites such as Meloidogyne sp., which may be of importance in agriculture. The compounds are also highly useful in treating acreage infested with fire and nests. The compounds are scattered above the infested area in low levels in bait formulations which are brought back to the nest. In addition to a direct-but-slow onset toxic effect on the fire ants, the compound has a long-term effect on the nest by sterilizing the queen which effectively destroys the nest.

Nodulisporic acid and its derivatives are also effective against arthropod pests, for example fleas, ticks, ice and other biting insects in domesticated animals and poultry, such as Ctenophalides, Ixodes, Psoroptes, Lucilia and Hematobia.

It is known to combine the above-mentioned classes of compounds in order to achieve a broader spectrum of activity or, in some instances synergy. For example, U.S. Pat. No. 5,945,317 discloses co-administering nodulisporic acid derivatives with avermectin or milbemycins, or other antihelmintic agents, such as morantel, pyrantel, or febantel, or benzimidizoles, such as thiabendazole or cambendazole. Other agents described therein include IGR compounds, such as lufenuron, or 1-N-arylpyrazoles, such a fipronil. See also, U.S. Pat. No. 5,962,499 and 6,221,894. While it is known in the art that it is sometimes possible to combine various parasiticides in order to broaden the antiparasitical spectrum, it is not possible to predict, a priori, which combinations will work for a particular animal or disease state. For this reason, the results of various combinations is not always successful and there is a need in the art for more effective formulations which may be easily administered to the animal.

Various methods of formulating antiparasitical formulations are known in the art. These include oral formulations, baits, dietary supplements, powders, shampoos, etc. Formulations for localized topical applications of antiparasitical formulations are also known in the art. For example, pour-on solutions comprising 1-N-phenylpyrazoles, such as fipronil, are known in the art and are described in copending application Ser. No. 08/933,016, herein incorporated by reference. Other methods for formulating antiparasitic agents include spot-on formulations.

Spot-on formulations are well known techniques for topically delivering an antiparasitic agent to a limited area of the host. For example, U.S. Pat. No. 5,045,536 describes such formulations for ectoparasites. Moreover, it is generally known in the art to formulate avermectin and milbemycin derivatives as spot-on formulations. See, e.g. U.S. Pat. No. 5,045,536; EP 677,054; U.S. Pat. No. 5,733,877; U.S. Pat. No. 5,677,332; U.S. Pat. No. 5,556,868; and U.S. Pat. No. 5,723,488. U.S. Pat. Nos. 5,962,499 and 5,595,998 generally discusses formulating nodulisporic acid derivatives as pour-on or spot-on formulations, with or without additional antiparasitic agents. However, as discussed in U.S. Pat. No. 5,045,536, a large number of solvent systems described in the art provide formulations for localized topical application which cause irritancy or toxicity to the host as well as being effective for a long period of time. Hence, there is a need in the art both for more effective for a longer period of time and less irritant or toxic formulations. Thus, there is a need in the art for a spot-on formulation, which is effective over a long period of time against a wide range of endoparasites and ectoparasites in birds and mammals.

### SUMMARY OF THE INVENTION

The invention provides inter alia for spot-on formulations for the treatment or prophylaxis of endoparasites of mammals, fish and birds, and in particular, cats, dogs, horses, chickens, sheep and cattle with the aim of ridding these hosts of all the parasites commonly encountered by birds and mammals. The invention also provides for effective and lasting destruction of ectoparasites, such as fleas, ticks, mites, e.g. itch mites, mosquitoes, flies and lice. Further, the spot-on formulations retain their efficacy over a long period of time, thereby reducing the number of applications of the formulation to the animal.

In particular this invention provides for spot-on formulations for the treatment or prophylaxis of parasite infestations in mammals or birds, which comprise:

(1) a composition comprising an effective amount of at least one nodulisporic acid derivative;

(2) a pharmaceutically or veterinary liquid carrier vehicle; and

(3) optionally, a crystallization inhibitor.

The invention also provides for an easy method of treating parasitic infestations or for the prophylaxis of parasite infestations in mammals or birds which comprises topically applying to said mammal or bird an effective amount of a formulation according to the present invention.

This invention further provides for formulations which, when applied locally, will diffuse over the entire body of the host and then dry, without crystallizing, and which do not affect the appearance of the coat after drying by, for example, leaving crystals or making the coat sticky. This has the further advantage in animals which groom themselves of not being orally ingested, where the therapeutic agent might not be well tolerated orally or might interact with other therapeutic agents.

The very high effectiveness of the method and of the formulations according to the invention provides not only for a high instantaneous effectiveness but also for an effectiveness of very long duration after the treatment of the animal.

This invention further provides for an amidation process to prepare amide derivatives of nodulisporic acid in higher yield with better purity. Novel intermediates in this process also form a part of this invention.

In this disclosure and in appended claims, terms such as “comprising” and “comprises” and the like, have the meanings ascribed to them in U.S. Patent Case Law. The terms “comprises” and “comprising” are open-ended and allow for the inclusion of additional ingredients or steps.

Clearly, a spot-on formulation spot-on comprising at least one nodulisporic acid derivative, advantageously t-butyl nodulisporamide in a veterinary acceptable liquid carrier vehicle is a basic or novel feature of the herein invention, as well as methods for preventing or treating parasites on an animal, e.g., dog, cat, by applying the formulation, e.g., monthly, and methods for preparing the formulations, e.g., by administering the ingredients, are also novel and basic features of the invention. That the invention performs as herein described is surprising, unexpected and nonobvious.

These and other embodiments are disclosed or are obvious from and encompassed by, the following Detailed Description.

### DETAILED DESCRIPTION

This invention provides for a spot-on formulation for the treatment and prophylaxis of parasite infestation in mammals or birds which comprises

(1) an effective amount of at least one nodulisporic acid derivative

(2) a pharmaceutically or veterinary acceptable liquid carrier vehicle; and

(3) optionally, a crystallization inhibitor

More especially preferred are spot-on formulations comprising:

(1) an effective amount of at least one nodulisporic acid derivative;

(2) a liquid carrier vehicle comprises a solvent and optionally a cosolvent wherein the solvent is selected from the group consisting of acetone, acetonitrile, benzyl alcohol, butyl diglycol, dimethylacetamide, dimethylformamide, dipropylene glycol n-butyl ether, ethanol, isopropanol, methanol, diethylene glycol monoethyl ether, ethylene glycol monomethyl ether, monomethylacetamide, dipropylene glycol monomethyl ether, liquid polyoxyethylene glycols, propylene glycol, 2-pyrrolidone, in particular N-methylpyrrolidone, diethylene glycol monoethyl ether, ethylene glycol, diethyl phthalate fatty acid esters, such as the diethyl ester or diisobutyl adipate, and a mixture of at least two of these solvents and the cosolvent is selected from the group consisting of absolute ethanol, isopropanol or methanol; and

(3) optionally, a crystallization inhibitor selected from the group consisting of an anionic surfactant, a cationic surfactant, a non-ionic surfactant, an amine salt, an amphoteric surfactant or polyvinylpyrrolidone, polyvinyl alcohols, copolymers of vinyl acetate and vinylpyrrolidone, polyethylene glycols, benzyl alcohol, mannitol, glycerol, sorbitol, polyoxyethylenated sorbitan esters; lecithin, sodium carboxymethylcellulose, and acrylic derivatives, or a mixture of these crystallization inhibitors.

This invention includes all nodulisporic acid derivatives know in the art, including all steroisomers, such as those described in the prior publication described above, which are expressly incorporated by reference. Especially preferred are spot-on formulations comprising nordulisporic acid derivatives of the formula:

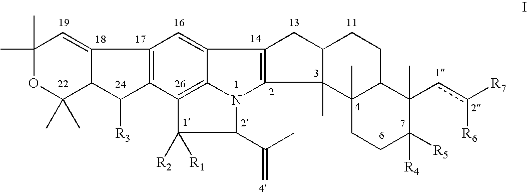

wherein

R¹ is (1) hydrogen,

(2) optionally substituted alkyl,

(3) optionally substituted alkenyl,

(4) optionally substituted alkynyl,

(5) optionally substituted cycloalkyl,

(6) optionally substituted cycloalkenyl,

where the substituents on the alkyl, alkenyl, alkynyl, cycloalkyl and cycloalkenyl are 1 to 3 groups independently selected from

(i) alkyl,

(ii) alkyl, where X is O or S(O)ₘ.

(iii) cycloalkyl,

(iv) hydroxy,

(v) halogen,

(vi) cyano,

(vii) carboxy,

(viii) NY Y², where Y¹ and Y² are independently H or alkyl,

(ix) alkanoylamino, and

(x) aroylamino wherein said aroyl is optionally substituted with 1 to 3 groups independently selected from R^{f}

(7) aryl or arylalkyl, wherein said aryl is optionally substituted with 1 to 3 groups independently selected from R^{f},

(8) perfluoroalkyl

(9) a 5- or 6-member heterocycle containing from 1 to 4 heteroatoms independently selected from oxygen, sulfur and nitrogen atoms optionally substituted by 1 to 3 groups independently selected from hydroxy, oxo, alkyl and halogen, and which may be saturated or partly unsaturated,

R₂, R₃, and R₄ are independently OR^{a}, OCO₂R^{b}, OC(O)NR^{c}R^{d}; or

R₁ and R₂ represent ═O, ═NOR^{a} or ═N—NR^{c}R^{d};

R₅ and R₆ are H; or

R₅ and R₆ together represent —O—;

R₇ is (1) CHO, or

(2), the fragment

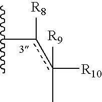

R₈ is (1) H,

(2) OR^{a}, or

(3) NR^{c}R^{d}

R₉ is (1) H, or

(2) OR^{a};

R₁₀ is (1) CN,

(2) C(O)OR^{b},

(3) C(O)N(OR^{b})R^{c},

(4) C(O)NR^{c}R^{d},

(5) NHC(O)OR^{b},

(6) NHC(O)NRCR^{d},

(7) CH₂OR^{a},

(8) CH₂OCO₂R^{b},

(9) CH₂OC(O)NR^{c}R^{d},

(10) C(O)NR^{c}NR^{c}R^{d}, or

(11) C(O)NR^{c}SO₂R^{b};

[symbol] represents a single or a double bond;

R^{a} is (1) hydrogen,

(2) optionally substituted alkyl,

(3) optionally substituted alkenyl,

(4) optionally substituted alkynyl,

(5) optionally substituted alkanoyl,

(6) optionally substituted alkenoyl,

(7) optionally substituted alkynoyl,

(8) optionally substituted aroyl,

(9) optionally substituted aryl,

(10) optionally substituted cycloalkanoyl,

(11) optionally substituted cycloalkenoyl,

(12) optionally substituted alkylsulfonyl

(13) optionally substituted cycloalkyl

(14) optionally substituted cycloalkenyl

where the substituents on the alkyl, alkenyl, alkynyl, alkanoyl, alkenoyl, alkynoyl, aroyl, aryl, cycloalkanoyl, cycloalkenoyl, alkylsulfonyl, cycloalkyl and cycloalkenyl are from 1 to 10 groups independently selected from hydroxy, alkoxy, cycloalkyl, arylalkoxy, NR^{g}R^{h}, CO₂R_{b}, CONR^{c}R^{d} and halogen,

(15) perfluoroalkyl,

(16) arylsulfonyl optionally substituted with 1 to 3 groups independently selected from alkyl, perfluoroalkyl, nitro, halogen and cyano,

(17) a 5- or 6-member heterocycle containing 1 to 4 heteroatoms selected from oxygen, sulfur and nitrogen optionally substituted by 1 to 4 groups independently selected from alkyl, alkenyl, perfluoroalkyl, amino, C(O)NR^{c}R^{d}, cyano, CO₂R^{b} and halogen, and which may be saturated or partly unsaturated;

R¹ is (1) H,

(2) optionally substituted aryl,

(3) optionally substituted alkyl,

(4) optionally substituted alkenyl,

(5) optionally substituted alkynyl,

(6) optionally substituted cycloalkyl,

(7) optionally substituted cycloalkenyl, or

(8) optionally substituted

heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups independently selected from

(i) hydroxy,

(ii) alkyl,

(iii) oxo,

(iv) SO₂NR^{g}R^{h},

(v) arylalkoxy,

(vi) hydroxyalkyl,

(vii) alkoxy,

(viii) hydroxyalkoxy,

(ix) aminoalkoxy,

(x) cyano,

(xi) mercapto,

(xii) alkyl-S(O)ₘ,

(xiii) cycloalkyl optionally substituted

with 1 to 4 groups independently selected from R^{e},

(xiv) cycloalkenyl,

(xv) halogen,

(xvi) alkanoyloxy,

(xvii) C(O)NR^{g}R^{h},

(xviii) CO₂Rⁱ,

(xix) formyl,

(xx) —NR^{g}R^{h}

(xxi) 5 to 9-member heterocycle, which may be saturated or partially unsaturated, containing from 1 to 4 heteroatoms independently selected from oxygen, sulfur and nitrogen, and optionally substituted with 1 to 5 groups independently selected from R^{e},

(xxii) optionally substituted aryl, wherein the aryl substituents are 1,2-methylenedioxy or 1 to 5 groups independently selected from R^{e},

(xxiii) optionally substituted arylalkoxy,

wherein the aryl substituents are 1,2-methylenedioxy or 1 to 5 groups independently selected from R^{e}, and

(xxiv) perfluoroalkyl;

R^{c} and R^{d} are independently selected from R^{b}; or

R^{c} and R^{d} together with the N to which they are attached form a 3- to 10-member ring containing 0 to 2 additional heteroatoms selected from O, S(O)ₘ, and N, optionally substituted with 1 to 3 groups independently selected from R^{g}, hydroxy, thioxo and oxo;

R^{e} is (1) halogen,

(2) alkyl,

(3) perfluoroalkyl,

(4) —S(O)ₘRⁱ,

(5) cyano,

(6) nitro,

(7) R₁₀(CH₂)ᵥ—,

(8) RⁱCO₂(CH₂)ᵥ—,

(9) RⁱOCO(CH₂)ᵥ—,

(10) optionally substituted aryl where the substituents are from 1 to 3 of halogen, alkyl, alkoxy, or hydroxy,

(11) SO₂NR^{g}R^{h}, or

(12) amino;

R^{f} is (1) alkyl,

(2) X—C₁-C₄ alkyl, where X is O or S(O)ₘ,

(3) alkenyl,

(4) alkynyl,

(5) perfluoroalkyl,

(6) NY¹Y², where Y¹ and Y² are independently H or alkyl,

(7) hydroxy,

(8) halogen, and

(9) alkanoylamino,

R^{g} and R^{h} are independently

(1) hydrogen,

(2) alkyl optionally substituted with hydroxy, amino, or CO₂Rⁱ

(3) aryl optionally substituted with halogen, 1,2-methylenedioxy, alkoxy, alkyl or perfluoroalkyl,

(4) arylalkyl, wherein the aryl is optionally substituted with perfluorolkyl or 1,2-methylenedioxy;

(5) alkoxycarbonyl,

(6) alkanoyl,

(7) alkanoylalkyl,

(9) aryl alkoxycarbonyl,

(10) aminocarbonyl,

(11) monoalkylaminocarbonyl

(12) dialkylaminocarbonyl; or

R^{g} and R^{h} together with the N to which they are attached form a 3- to 7-member ring containing 0 to 2 additional heteroatoms selected from O, S(O)ₘ, and N, optionally substituted with 1 to 3 groups independently selected from R^{e} and oxo;

Rⁱ is (1) hydrogen,

(2) perfluoroalkyl,

(3) alkyl,

(4) optionally substituted aryl or arylalkyl, where the aryl substituents are from 1 to 3 groups independently selected from halogen, alkyl, alkoxy, and hydroxy;

m is 0 to 2; and

v is 0 to 3; or

a pharmaceutically acceptable salt thereof.

In a preferred embodiment, the present invention provides compounds of Formula I wherein

R₁ is (1) hydrogen,

(2) optionally substituted alkyl,

(3) optionally substituted alkenyl,

(4) optionally substituted alkynyl,

(5) optionally substituted cycloalkyl,

(6) optionally substituted cycloalkenyl where the substituents on the alkyl, alkenyl, alkynyl, cycloalkyl and cycloalkenyl are 1 to 3 groups independently selected from

(i) alkyl,

(ii) X—C₁-C₆ alkyl, where X is O or S(O)ₘ,

(iii) cycloalkyl,

(iv) hydroxy,

(v) halogen,

(vi) cyano,

(vii) carboxy, and

(viii) NY¹Y², where Y¹ and Y² are independently H or alkyl,

(7) aryl or arylalkyl wherein said aryl is optionally substituted with 1 to 3 groups independently selected from R^{f},

(8) perfluoroalkyl,

(9) a 5- or 6-member heterocycle containing from 1 to 4 heteroatoms independently selected from oxygen, sulfur and nitrogen atoms optionally substituted by 1 to 3 groups independently selected from hydroxy, oxo, alkyl and halogen, and which may be saturated or partly unsaturated,

R₈ is (1) H,

(2) OH, or

(3) NH₂;

R₉ is (1) H or

(2) OH;

R₁₀ is (1) C(O)OR^{b},

(2) C(O)N(OR^{b})R^{c},

(3) C(O)NR^{c}R^{d},

(4) NHC(O)OR^{b},

(5) NHC(O)NR^{c}R^{d},

(6) CH₂OR^{a},

(7) CH₂OCO₂R^{b},

(8) CH₂OC(O)NR^{c}R^{d},

(9) C(O)NR^{c}NR^{c}R^{d}, or

(10) C(O)NR^{c}SO₂R^{b};

R^{a} is (1) hydrogen,

(2) optionally alkyl,

(3) optionally substituted alkenyl,

(4) optionally substituted alkynyl,

(5) optionally substituted alkanoyl,

(6) optionally substituted alkenoyl,

(7) optionally substituted alkynoyl,

(8) optionally substituted aroyl,

(9) optionally substituted aryl,

(10) optionally substituted cycloalkanoyl,

(11) optionally substituted cycloalkenoyl,

(12) optionally substituted alkylsulfonyl

(13) optionally substituted cycloalkyl

(14) optionally substituted cycloalkenyl where the substituents on the alkyl, alkenyl, alkynyl, alkanoyl, alkenoyl, alkynoyl, aroyl, aryl, cycloalkanoyl, cycloalkenoyl, alkylsulfonyl, cycloalkyl and cycloalkenyl are from 1 to 10 groups independently selected from hydroxy, alkoxy, cycloalkyl, aryl alkoxy, NR^{g}R^{h}, CO₂R^{b}, CONR^{c}R^{d} and halogen,

(15) perfluoroalkyl,

(16) arylsulfonyl optionally substituted with 1 to 3 groups independently selected from alkyl, perfluoroalkyl, halogen and cyano,

(17) a 5- or 6-member heterocycle containing 1 to 4 heteroatoms selected from oxygen, sulfur and nitrogen optionally substituted by 1 to 4 groups independently selected from alkyl, alkenyl, perfluoroalkyl, amino, C(O)NR^{c}R^{d}, cyano, CO₂R^{b} and halogen, and which may be saturated or partly unsaturated;

R^{b} is (1) H,

(2) optionally substituted aryl,

(3) optionally substituted alkyl,

(4) optionally substituted alkenyl,

(5) optionally substituted alkynyl,

(6) optionally substituted cycloalkyl,

(7) optionally substituted cycloalkenyl, or

(8) optionally substituted 5- to 10-member

heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups independently selected from

(i) hydroxy,

(ii) C₁-C₃ alkyl,

(iii) oxo,

(iv) SO₂NR^{g}R^{h},

(v) aryl alkoxy,

(vi) hydroxy alkyl,

(vii) alkoxy,

(viii) hydroxyalkoxy,

(ix) aminoalkoxy,

(x) cyano,

(xi) perfluoroalkyl,

(xii) alkyl-S(O)ₘ,

(xiii) cycloalkyl optionally substituted

with 1 to 4 groups independently selected from R^{e},

(xiv) cycloalkenyl,

(xv) halogen,

(xvi) alkanoyloxy,

(xvii) C(O)NR^{g}R^{h},

(xviii) CO₂Rⁱ,

(xix) optionally substituted arylalkoxy,

wherein the aryl substituents are 1,2-methylenedioxy or 1 to 5 groups independently selected from R^{e},

(xx) —NR^{g}R^{h},

(xxi) 5 to 6-member heterocycle, which may be saturated or partially unsaturated, containing from 1 to 4 heteroatoms independently selected from oxygen, sulfur and nitrogen, and optionally substituted with 1 to 5 groups independently selected from R^{e}, and

(xxii) optionally substituted aryl, wherein the aryl substituents are 1,2-methylenedioxy or 1 to 5 groups independently selected from R^{e};

R^{e} is (1) halogen,

(2) alkyl,

(3) perfluoroalkyl,

(4) —S(O)ₘRⁱ,

(5) cyano,

(6) amino,

(7) RⁱI(CH₂)ᵥ—,

(8) RⁱCO₂(CH₂)ᵥ—,

(9) RⁱOCO(CH₂)ᵥ—,

(10) optionally substituted aryl where the substituents are from 1 to 3 of halogen, alkyl, alkoxy, or hydroxy, or

(11) SO₂NR^{g}R^{h};

R^{f} is (1) methyl,

(2) X—C1-C₂ alkyl, where X is O or S(O)ₘ,

(3) halogen,

(4) acetylamino,

(5) trifluoromethyl,

(6) NY¹Y², where Y¹ and Y² are independently H or methyl, and

(7) hydroxy;

R^{g} and R^{h} are independently

(1) hydrogen,

(2) alkyl optionally substituted with hydroxy, amino, or CO₂Rⁱ

(3) aryl optionally substituted with halogen, 1,2-methylenedioxy, alkoxy, alkyl or perfluoroalkyl,

(4) arylalkyl, wherein the aryl is optionally substituted with perfluorolkyl or 1,2-methylenedioxy;

(5) alkoxycarbonyl,

(6) alkanoyl,

(7) alkanoyl alkyl,

(9) arylalkoxycarbonyl,

(10) aminocarbonyl,

(11) monoalkylaminocarbonyl

(12) dialkylaminocarbonyl; or

R^{g} and R^{h} together with the N to which they are attached form a 5- to 6-member ring containing 0 to 2 additional heteroatoms selected from O, S(O)ₘ, and N, optionally substituted with 1 to 3 groups independently selected from R^{e} and oxo;

Rⁱ is (1) hydrogen,

(2) perfluoroalkyl,

(3) alkyl,

(4) optionally substituted arylalkyl, where the aryl substituents are from 1 to 3 groups independently selected from halogen, alkyl, alkoxy, and hydroxy; all other variables are as defined under Formula I.

In another preferred embodiment, the present invention provides compounds of Formula I wherein

Rᵢ is (1) hydrogen,

(2) optionally substituted alkyl,

(3) optionally substituted alkenyl,

(4) optionally substituted alkynyl,

where the substituents on the alkyl, alkenyl, and alkynyl are 1 to 3 groups independently selected from

(i) methyl,

(ii) X-methyl, where X is O or S(O)ₘ and

(iii) halogen,

(5) aryl or arylalkyl wherein said aryl is optionally substituted with 1 to 3 groups independently selected from R^{f}.

(6) trifluoromethyl

R₈ is (1) H,

(2) OH, or

(3) NH₂

R₉ is (1) H, or

(2) OH;

R₁₀ is (1) C(O)OR^{b},

(2) C(O)N(OR^{b})R^{c},

(3) C(O)NR^{c}R^{d},

(4) NHC(O)OR^{b},

(5) NHC(O)NR^{c}R^{d},

(6) CH₂OR^{a},

(7) CH₂OCO₂R^{b},

(8) CH₂OC(O)NR^{c}R^{d},

(9) C(O)NR^{c}NR^{c}R^{d} or

(10) C(O)NR^{c}SO₂R^{b};

R^{a} is (1) hydrogen,

(2) optionally substituted alkyl,

(3) optionally substituted alkenyl,

(4) optionally substituted alkynyl,

(5) optionally substituted alkanoyl,

(6) optionally substituted aroyl,

(7) optionally substituted cycloalkanoyl,

(8) optionally substituted cycloalkenoyl,

(9) optionally substituted alkylsulfonyl

where the substituents on the alkyl, alkenyl, alkynyl, alkanoyl, aroyl, cycloalkanoyl, cycloalkenoyl, and alkylsulfonyl, are from 1 to 5 groups independently selected from hydroxy, alkoxy, aryl alkoxy, NR^{g}R^{h}, CO₂R^{b}, CONR^{c}R^{d} and halogen,

(10) trifluoromethyl,

(11) arylsulfonyl optionally substituted with 1 to 3 groups independently selected from methyl, trifluoromethyl and halogen,

(12) a 5- or 6-member heterocycle containing 1 to 4 heteroatoms selected from oxygen, sulfur and nitrogen optionally substituted by 1 to 4 groups independently selected from methyl, trifluoromethyl, C(O)NR^{c}R^{d}, CO₂R^{b} and halogen, and which may be saturated or partly unsaturated;

R_{b} is (1) H,

(2) optionally substituted aryl,

(3) optionally substituted alkyl,

(4) optionally substituted alkenyl,

(5) optionally substituted alkynyl,

(6) optionally substituted cycloalkyl,

(7) optionally substituted cycloalkenyl, or

(8) optionally substituted 5- to 6-member

heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups independently selected from

(i) hydroxy,

(ii) alkyl,

(iii) oxo,

(iv) SO₂NR^{g}R^{h},

(v) arylalkoxy,

(vi) hydroxyalkyl,

(vii) alkoxy,

(viii) hydroxy alkoxy,

(ix) amino alkoxy,

(x) cyano,

(xi) alkyl-S(O)ₘ,

(xii) cycloalkyl optionally substituted with 1 to 4 groups independently selected from R^{e},

(xiii) cycloalkenyl,

(xiv) halogen,

(xv) alkanoyloxy,

(xvi) C(O)NR^{g}R^{h},

(xvii) CO₂Rⁱ,

(xvii) —NR^{g}R^{h},

(xix) 5 to 6-member heterocycle, which may be saturated or partially unsaturated, containing from 1 to 4 heteroatoms independently selected from oxygen, sulfur and nitrogen, and optionally substituted with 1 to 5 groups independently selected from R^{e},

(xx) optionally substituted aryl, wherein the aryl substituents are 1,2-methylenedioxy or 1 to 5 groups independently selected from R^{e},

(xxi) optionally substituted aryl alkoxy, wherein the aryl substituents are 1,2-methylenedioxy or 1 to 5 groups independently selected from R^{e}, and

(xxii) perfluoroalkyl;

R^{e} is (1) halogen,

(2) alkyl,

(3) perfluoroalkyl,

(4) —S(O)ₘRⁱ,

(5) cyano,

(6) RⁱO(CH₂)ᵥ—,

(7) RⁱCO₂(CH₂)ᵥ—,

(8) R₁₀CO(CH₂)ᵥ—,

(9) optionally substituted aryl where the substituents are from 1 to 3 of halogen, alkyl, alkoxy, or hydroxy,

(10) SO₂NR^{g}R^{h}, or

(11) amino;

R^{f} is (1) methyl,

(2) X—C₁-C₂ alkyl, where X is O or S(O)ₘ,

(3) trifluoromethyl,

(4) NY¹Y², where Y¹ and Y² are independently H or methyl,

(5) hydroxy,

(6) halogen, and

(7) acetylamino,

R^{g} and R^{h} are independently

(1) hydrogen,

(2) alkyl optionally substituted with hydroxy, amino, or CO₂R

(3) aryl optionally substituted with halogen, 1,2-methylenedioxy, alkoxy, alkyl or perfluoroalkyl,

(4) arylalkyl, wherein the aryl is optionally substituted with perfluorolkyl or 1,2-methylenedioxy;

(5) alkoxycarbonyl,

(6) alkanoyl,

(7) alkanoylalkyl,

(9) arylalkoxycarbonyl,

(10) aminocarbonyl,

(11) monoalkylaminocarbonyl

(12) dialkylaminocarbonyl; or

R^{g} and R^{h} together with the N to which they are attached form a 5- to 6-membered ring containing 0 to 2 additional heteroatoms selected from O, S(O)ₘ, and N, optionally substituted with 1 to 3 groups independently selected from R^{e} and oxo;

Rⁱ is (1) hydrogen,

(2) perfluoroalkyl,

(3) alkyl,

(4) optionally substituted aryl or arylalkyl, where the aryl substituents are from 1 to 3 groups independently selected from halogen, alkyl, alkoxy, and hydroxy; and all other variables are as defined under Formula I. In another aspect of the present invention there are provided compounds having the formula

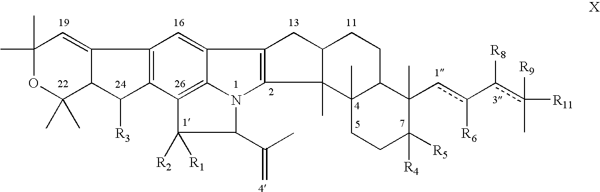

where R₁-R₆, R₈ and R₉ are as defined under Formula I; and

R₁₁ is (1) COCl,

(2) CON₃, or

(3) NCO.

Most especially preferred are spot-on compositions, wherein the composition comprises nodulisporic acid derivatives which are nodulisporamides, which are compounds of the formula

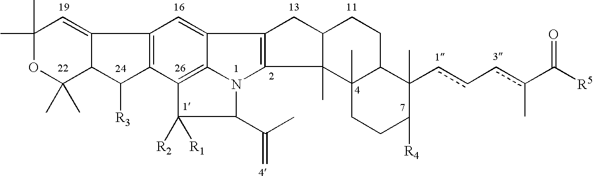

R₁ is

(1) hydrogen,

(2) optionally substituted C₁-C₁₀ alkyl,

(3) optionally substituted C₂-C₁₀ alkenyl,

(4) optionally substituted C₂-C₁₀alkynyl,

(5) optionally substituted C₃-C₈ cycloalkyl,

(6) optionally substituted C₅-C₈ cycloalkenyl

where the substituents on the alkyl, alkenyl, alkynyl, cycloalkyl and cycloalkenyl are 1 to 3 groups independently selected from C₁-C₅ alkyl, C₁-C₁₀ alkoxy, C₁-C₁₀ alkylthio, C₁-C₁₀ alkylsulfonyl, C₃-C₈ cycloalkyl, hydroxy, halogen, cyano, carboxy, amino, C₁-C₁₀ monoalkylamino, C₁-C₁₀ dialkylamino, C₁-C₁₀ alkanoyl amino and benzoyl amino wherein said benzoyl is optionally substituted with 1 to 3 groups independently selected from C₁-C₄ alkyl, C₁-C₄ alkoxy, C₁-C₄ alkylthio, C₂-C₄ alkenyl, C₂-C₄ alkynyl, C₁-C₃ perfluoroalkyl, amino, hydroxy, halogen, C₁-C₅ monoalkylamino, C₁-C₅ dialkylamino and C₁-C₅ alkanoyl amino,

(7) phenyl C₀₋C₅ alkyl wherein said phenyl is optionally substituted with 1 to 3 groups independently selected from C₁-C₄ alkyl, C₁-C₄ alkoxy, C₁-C₄ alkylthio, C₂-C₄ alkenyl, C₂-C₄ alkynyl, C_{1-C}₃ perfluoroalkyl, amino, hydroxy, carboxy, halogen, C₁-C₅ monoalkylamino, C₁-C₅ dialkylamino and C₁-C₅ alkanoyl amino,

(8) C₁-C₅ perfluoroalkyl,

(9) a 5- or 6-member ring selected from morpholino, pyridyl and piperazino, optionally substituted by 1 to 3 groups independently selected from hydroxy, oxo, C₁-C₁₀ alkyl and halogen,

R², R³, and R⁴ are independently OR^{a}, OCO₂R^{b}, OC(O)NR^{c}R^{d}; or

R¹ and R² together represent ═O, ═NOR^{a} or ═N—NR^{c}R^{d};

R⁵ is NR^{c}R^{d},

R ^{a} is

(1) hydrogen,

(2) optionally substituted C₁-C₁₀ alkyl,

(3) optionally substituted C₃-C₁₀ alkenyl,

(4) optionally substituted C₃-C₁₀ alkynyl,

(5) optionally substituted C₁-C₁₀ alkanoyl,

(6) optionally substituted C₁-C₁₀ alkenoyl,

(7) optionally substituted C₁-C₁₀ alkynoyl,

(8) optionally substituted benzoyl,

(9) optionally substituted phenyl,

(10) optionally substituted C₁-C₇ cycloalkanoyl,

(11) optionally substituted C₄-C₇ cycloalkenoyl,

(12) optionally substituted C₁-C₁₀ alkylsulfonyl

(13) optionally substituted C₃-C₈ cycloalkyl

(14) optionally substituted C₅-C₈ cycloalkenyl

where the substituents on the alkyl, alkenyl, alkynyl, alkanoyl, alkenoyl, alkynoyl, benzoyl, phenyl, cycloalkanoyl, cycloalkenoyl, alkylsulfonyl, cycloalkyl and cycloalkenyl are from 1 to 5 groups independently selected from hydroxy, C₁-C₆ alkoxy, C₃-C₇ cycloalkyl, aryl C₁-C₃ alkoxy, NR^{g}R^{h}, CO₂R^{b}, CONR^{c}R^{d} and halogen,

(15) C₁-C₅ perfluoroalkyl,

(16) phenylsulfonyl optionally substituted with 1 to 3 groups independently selected from C₁-C₅ alkyl, C₁₋C₅ perfluoroalkyl, nitro, halogen or cyano,

(17) a 5- or 6-member ring selected from piperidino, morpholino, pyridyl and piperazino optionally substituted by 1 to 4 groups independently selected from C₁-C₅ alkyl, C₁-C₅ alkenyl, C₁-C₅ perfluoroalkyl, amino, C(O)R^{c}R^{d}, cyano, CO₂R^{b} or halogen;

R^{b} is

(1) H,

(2) optionally substituted phenyl,

(3) optionally substituted C₁-C₁₀ alkyl,

(4) optionally substituted C₃-C₁₀ alkenyl, or

(5) optionally substituted C₃-C₁₀ alkynyl,

where the substituents on the phenyl, alkyl, alkenyl or alkynyl are from 1 to 5 groups independently selected from hydroxy, C₁-C₆ alkoxy, C₃-C₇ cycloalkyl, halogen, C₁-C₅ alkanoyloxy, C(O)NR^{c}R^{d}, CO₂R^{b}, formyl, —NR^{g}R^{h}, optionally substituted phenyl, and optionally substituted phenyl C₁-C₃ alkoxy, wherein the phenyl substituents are 1 to 3 groups independently selected from R^{e};

R^{c} and R^{d} are independently R^{b}; or

R^{c} and R^{d} together with the N to which they are attached form a piperidino, morpholino or piperazino optionally substituted with 1 to 3 groups independently selected from R^{g} and oxo;

R^{e} is

(1) halogen,

(2) C₁-C₇ alkyl,

(3) C₁-C₃ perfluoroalkyl,

(4) —S(O)ₘRⁱ,

(5) cyano,

(6) nitro,

(7) R^{j}O(CH₂)ᵥ—,

(8) R^{j}CO₂ (CH₂)ᵥ—,

(9) R^{j}OCO(CH₂)ᵥ⁻,

(10) optionally substituted phenyl where the substituents are from 1 to 3 halogen, C₁-C₆ alkyl, C₁-C₆ alkoxy, or hydroxy;

v is 0 to 3;

R^{g} and R^{h} are independently

(1) hydrogen,

(2) C₁-C₆ alkyl,

(3) aryl,

(4) aryl C₁-C₆ alkyl,

(5) C₁-C₅ alkoxycarbonyl,

(6) C₁-C₅ alkylcarbonyl, or

(7) C₁-C₅ alkanoyl C₁-C₅ alkyl; or

R^{g} and R^{h} together with the N to which they are attached form a piperidino, morpholino or piperazino optionally substituted with 1 to 3 groups independently selected from R^{g} and oxo;

Rⁱ and R^{j} are independently

(1) hydrogen,

(2) C₁-C₃ perfluoroalkyl,

(3) optionally substituted C₁-C₆ alkyl, where the substituents are aryl or substituted phenyl;

(4) phenyl or substituted phenyl where the substituents are from 1 to 3 groups independently selected from halogen, C₁-C₆ alkyl, C₁-C₆ alkoxy, or hydroxy;

m is 0 to 2; or a pharmaceutically acceptable salt thereof.

Most especially preferred are compounds of the formula

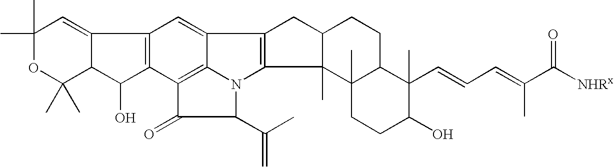

wherein R^{x} is selected from the group consisting of:

H, CH₃, CH₂CH₃, C(CH₃)₃, CH₂CH₂CH₃, CH₂CH₂OH, CH(CO₂CH₃)CH₂OH, CH₂CO₂CH₃, CH₂CH(OCH₂CH₃)₂, CH₂CH₂OCH₂CH₂OH, CH(CH₃)(CH₂)₃C(CH₃)₂OH, (CH₂)₃OH, (CH₂)₄OH, (CH₂)SOH, CH(CH₂OH)CH₂CH₃, NHC(CH₃)₃, CH₂CN, (CH₂)₆OH, CH₂CH(OH)CH₃, CH(CH₂OH)CH₂CH₂CH₃, CH₂CH₂SCH₃, CH₂CH₂SCH₂CH₃, CH₂CONH, CH(CH₃)(CH₂OH)₂, CH₂CH₂NHCH₂CH₂OH, CH(CH₂OH)(CH₂)₃CH₃, CH(CH₂OCH₃)CH₃, (CH₂)₂SH, (CH₂)₄NH₂, CH₂CH₂SO₂CH₃, CH₂CH₂S(O)CH₃, CH(CH(CH₃)₂)CH₂OH, (CH₂)₃NH₂, (CH₂)₃N(CH₂CH₃)₂, (CH₂)₃N(CH₃)₂, OCH₂CH₃, CH₂CH(OH)CH₂OH, OCH₃, CH₂CH₂OCH₃, CH₂CH₂NHC(O)CH₃, C(CH₃)₂CH₂OH, c-C₃H₅, c-C₆H₁₁, (CH₂)₃OCH₂CH₃, CH₂CH≡CH₂, C(CH₂CH₃)(CH₂OH)₂, CH₂C≡CH, CH₂CO₂CH₂CH₃, CH₂CH₂F, (CH₂)₃OCH₂)₁₁ CH₃, CH₂CH₂N(CH₃)₂, CH₂CH₂OCH₂CH₂NH₂, CH₂CF₃, NHCH₂CO₂CH₂CH₃, CH(CH₃)CO₂CH₃, C(CH₃)₂CH₂C(O)CH₃, CH(CO₂CH₂CH₃)₂, CH₂CH₃, CH(CH₂CH₂CH₃)CO₂CH₃, CH₂CH₂CH₂OCH₃, C(CH₃)₂C≡CH, (CH₂)₄CH₃, CH(CH₂CH₂CH₃)₂, (CH₂)₅CH₃, CH₂CH₂CO₂H, CH(CH(CH₃)₂)CO₂CH₃, OCH₂CO₂H, CH(CH(CH₃)₂)CH₂OH, CH(CH(CH₃)₂)CH₂OH, CH(CH₃)CH₂OH, CH(CH₃)CH₂OH, CH(CH₃)₂, C(CH₃)₃, (CH₂)CH(CH₃)₂, CH(CH₃)CH₂CH₃, CH₂CH(CH₃)OH, (CH₂)₃CH₃, (CH₂)₂OCH₂CH₃, 1-adamantyl, (CH₂)₈CH₃, CH(CH₃)CH(CH₃)₂, (CH₂)₃NHCH₃, (CH₂)₂N(CH₂CH₃)₂,

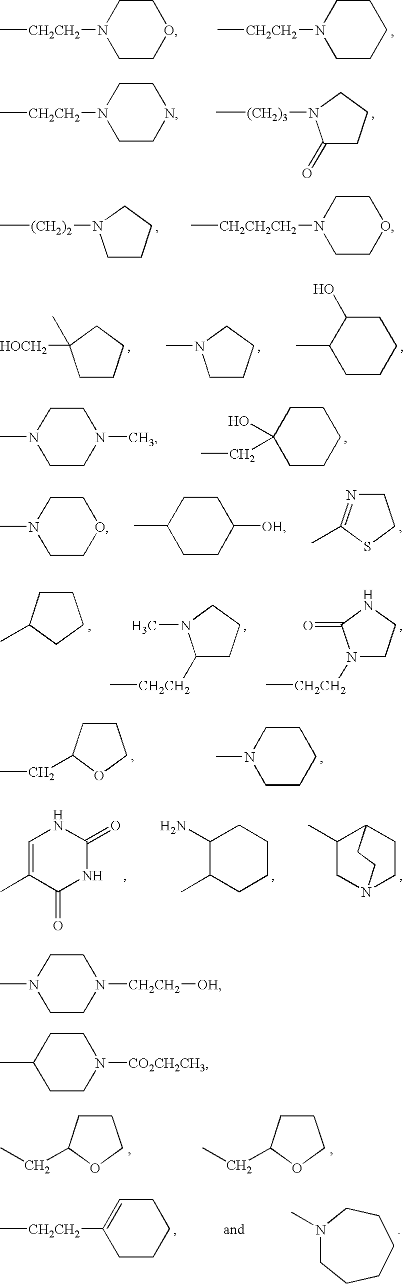

An especially preferred nodulisporamide derivative is one wherein R^{x} is with t-butyl being most especially preferred.

“Alkyl” as well as other groups having the prefix “alk”, such as alkoxy, alkanoyl, alkenyl, alkynyl and the like, means carbon chains which may be linear or branched or combinations thereof. Examples of alkyl groups include methyl, ethyl, propyl, isopropyl, butyl, sec- and tert-butyl, pentyl, hexyl, heptyl and the like. “Alkenyl”, “alkynyl” and other like terms include carbon chains containing at least one unsaturated C—C bond.

The term “cycloalkyl” means carbocycles containing no heteroatoms, and includes mono-, bi- and tricyclic saturated carbocycles, as well as benzofused carbocycles. Examples of cycloalkyl include cyclopropyl, cyclobutyl, cyclopentyl, cyclohexyl, decahydronaphthalene, adamantane, indanyl, indenyl, fluorenyl, 1,2,3,4-tetrahydronaphalene and the like. Similarly, “cycloalkenyl” means carbocycles containing no heteroatoms and at least one non-aromatic C—C double bond, and include mono-, bi- and tricyclic partially saturated carbocycles, as well as benzofused cycloalkenes. Examples of cycloalkenyl include cyclohexenyl, indenyl, and the like.

The term “halogen” is intended to include the halogen atoms fluorine, chlorine, bromine and iodine.

The term “heterocycle”, unless otherwise specfied, means mono- or bicyclic compounds that are saturated or partly unsaturated, as well as benzo- or heteroaromatic ring fused saturated heterocycles or partly unsaturated heterocycles, and containing from 1 to 4 heteroatorns independently selected from oxygen, sulfur and nitrogen. Examples of saturated heterocycles include morpholine, thiomorpholine, piperidine, piperazine, tetrahydropyran, tetrahydrofuran, dioxane, tetrahydrothiophene, oxazolidine, pyrrolidine; examples of partly unsaturated heterocycles include dihydropyran, dihydropyridazine, dihydrofuran, dihydrooxazole, dihydropyrazole, dihydropyridine, dihydropyridazine and the like. Examples of benzo- or heteroaromatic ring fused heterocycle include 2,3-dihydrobenzofuranyl, benzopyranyl, tetrahydroquinoline, tetrahydroisoquinoline, benzomorpholinyl, 1,4-benzodioxanyl, 2,3-dihydrofuro(2,3-b)pyridyl and the like.

The term “aryl” is intended to include mono- and bicyclic aromatic and heteroaromatic rings containing from 0 to 5 heteroatoms independently selected from nitrogen, oxygen and sulfur. The term “aryl” is also meant to include benzofused cycloalkyl, benzofused cycloalkenyl, and benzofused heterocyclic groups. Examples of “aryl” groups include phenyl, pyrrolyl, isoxazolyl, pyrazinyl, pyridinyl, oxazolyl, thiazolyl, imidazolyl, triazolyl, tetrazolyl, furanyl, triazinyl, thienyl, pyrimidinyl, pyridazinyl, pyrazinyl, naphthyl, benzoxazolyl, benzothiazolyl, benzimidazolyl, benzofuranyl, furo(2,3-B)pyridyl, 2,3-dihydrofuro(2,3-b)pyridyl, benzoxazinyl, benzothiophenyl, quinolinyl, indolyl, 2,3-dihydrobenzofuranyl, benzopyranyl, 1,4-benzodioxanyl, indanyl, indenyl, fluorenyl, 1,2,3,4-tetrahydronaphthalene and the like.

Aroyl means arylcarbonyl in which aryl is as defined above.

Examples of NR^{c}R^{d} or NR^{g}R^{h} forming a 3- to 10-membered ring containing 0 to 2 additional heteroatoms selected from O, S(O)ₘ and N are aziridine, azetidine, pyrrolidine, piperidine, thiomorpholine, morpholine, piperazine, octahydroindole, tetrahydroisoquinoline and the like.

The term “optionally substituted” is intended to include both substituted and unsubstituted; thus, for example, optionally substituted aryl could represent a pentafluorophenyl or a phenyl ring.

Certain of the above defined terms may occur more than once in the above formula and upon such occurrence each term shall be defined independently of the other; thus, for example, OR^{a} at C4 may represent OH

Compounds of formula (I) are available commercially or can be prepared according to one or other of the processes or any other process coming within the competence of a person skilled in the art who is an expert in chemical synthesis. For the chemical preparation of the products of the invention, a person skilled in the art is regarded as having at his disposal, inter alia, the entire contents of “Chemical Abstracts” and of the documents which are cited therein. Semi-synthetic processes are described, for example, in U.S. Pat. No. 6,399,786 or WO 96/29073, both of which are incorporated by reference.

A particularly effective synthetic method in order to prepare nodulisporamide compounds of the formula

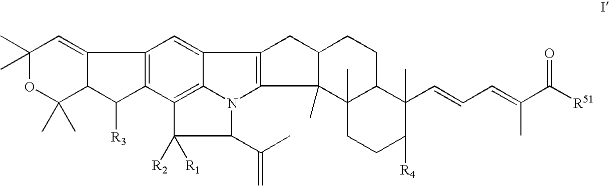

wherein R₁, R₂, R₃ and R₄ are defined above and R⁵¹ is NR^{c}R^{d} where R^{c}R^{d} are independently

(1) H,

(2) optionally substituted aryl,

(3) optionally substituted alkyl,

(4) optionally substituted alkenyl,

(5) optionally substituted alkynyl,

(6) optionally substituted cycloalkyl,

(7) optionally substituted cycloalkenyl, or

(8) optionally substituted heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups independently selected from

(i) hydroxy,

(ii) alkyl,

(iii) oxo,

(iv) SO₂NR^{g}R^{h},

(v) arylalkoxy,

(vi) hydroxyalkyl,

(vii) alkoxy,

(viii) hydroxyalkoxy,

(ix) aminoalkoxy,

(x) cyano,

(xi) mercapto,

(xii) alkyl-S(O)ₘ,

(xiii) cycloalkyl optionally substituted

with 1 to 4 groups independently selected from R^{e},

(xiv) cycloalkenyl,

(xv) halogen,

(xvi) alkanoyloxy,

(xvii) C(O)NR^{g}R^{h},

(xviii) CO₂Rⁱ,

(xix) formyl,

(xx) —NR^{g}R^{h},

(xxi) 5 to 9-member heterocycle, which may be saturated or partially unsaturated, containing from 1 to 4 heteroatoms independently selected from oxygen, sulfur and nitrogen, and optionally substituted with 1 to 5 groups independently selected from R^{e},

(xxii) optionally substituted aryl, wherein the aryl substituents are 1,2-methylenedioxy or 1 to 5 groups independently selected from R^{e},

(xxiii) optionally substituted arylalkoxy,

wherein the aryl substituents are 1,2-methylenedioxy or 1 to 5 groups independently selected from R^{e},

(xxiv) perfluoroalkyl; or

R^{c} and R^{d} together with the N to which they are attached form a 3- to 10-member ring containing 0 to 2 additional heteroatoms selected from O, S(O)ₘ, and N, optionally substituted with 1 to 3 groups independently selected from R^{g}, hydroxy, thioxo and oxo;

R^{e} is (1) halogen,

(2) alkyl,

(3) perfluoroalkyl,

(4) —S(O)ₘRⁱ,

(5) cyano,

(6) nitro,

(7) RⁱO(CH₂)ᵥ—,

(8) RⁱCO₂(CH₂)ᵥ—,

(9) RᵢOCO(CH₂)ᵥ—,

(10) optionally substituted aryl where the substituents are from 1 to 3 of halogen, alkyl, alkoxy, or hydroxy,

(11) SO₂NR^{g}R^{h}, or

(12) amino;

R^{f} is (1) alkyl,

(2) X-alkyl, where X is O or S(O)ₘ,

(3) alkenyl,

(4) alkynyl,

(5) perfluoroalkyl,

(6) NY¹Y², where Y¹ and Y² are independently H or alkyl,

(7) hydroxy,

(8) halogen, and

(9) alkanoyl amino,

R^{g} and R^{h} are independently

(1) hydrogen,

(2) alkyl optionally substituted with hydroxy, amino, or CO₂Rⁱ

(3) aryl optionally substituted with halogen, 1,2-methylenedioxy, alkoxy, alkyl or perfluoroalkyl,

(4) arylalkyl, wherein the aryl is optionally substituted with perfluorolkyl or 1,2-methylenedioxy;

(5) alkoxycarbonyl,

(6) alkanoyl,

(7) alkanoylalkyl,

(9) arylalkoxycarbonyl,

(10) aminocarbonyl,

(11) monoalkylaminocarbonyl

(12) dialkylaminocarbonyl; or

R^{g} and R^{h} together with the N to which they are attached form a 3- to 7-member ring containing 0 to 2 additional heteroatoms selected from O, S(O)ₘ, and N, optionally substituted with 1 to 3 groups independently selected from R^{e} and oxo;

Rⁱ is (1) hydrogen,

(2) perfluoroalkyl,

(3) alkyl,

(4) optionally substituted aryl, or arylalkyl, where the aryl substituents are from 1 to 3 groups independently selected from halogen, alkyl, alkoxy, and hydroxy;

m is 0 to 2; and

v is 0 to 3; or

said process comprising

(1) coupling a compound of formula II′

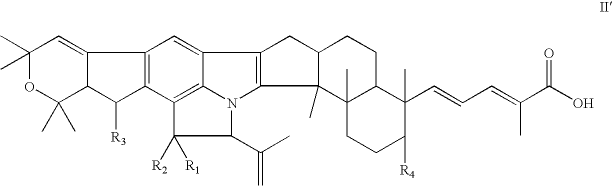

wherein

R¹, R², R³, and R⁴ are defined above,

with a compound of formula III

wherein R^{6′} and R^{7′} can be independently selected from alkyl, aminoalkyl or cycloalkyl, in the presence of an organic solvent to produce a first intermediate compound of the formula:

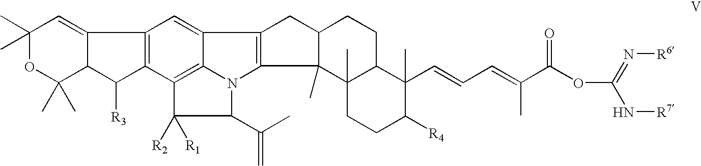

(2) reacting the first intermediate compound with an activating compound ACT, such as a compound of formula IV

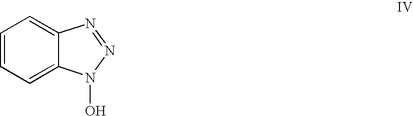

to produce a second intermediate compound of the formula:

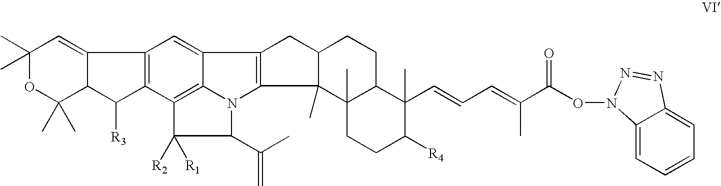

(3) adding an amine of the formula HNR^{c}R^{d} to the second intermediate compound to obtain a compound of formula I′.

This process is described in Provisional Application No. 60/415,627, entitled “Method for the Synthesis of Nodulisporamide,” filed on Oct. 2, 2002, herein incorporated by reference.

The advantage to the invention process is that the amidation reaction occurs under mild conditions, thereby reducing the potential of side reactions at the C₂₃-C₂₄ position or epimerization of C₇ of the starting material. This in turn increases the overall yield and purity of the final product. It is known that amidation under acidic conditions leads to dehydration of the C₂₃-C₂₄ position and amidation under basic conditions leads to epimerization of C₇; the inventive process is mild enough to reduce greatly the occurrence of these side reactions.

The inventive process achieves these results by performing the amidation reaction via an active intermediate by reacting the nodulisporic acid compound with a compound of formula III. Preferred compounds of formula III are N-N′-Diisopropylcarbodiimide (DIPCDI) N-N′-dicyclohexylcarbodimide (DCC), and 1-[(3-dimethylamino)propyl]-3-ethylcarbodimide HCl salt (EDC) with DCC being especially preferred. This intermediate may be isolated or it may be reacted in one step with an activating compound such as a 1-hydroxybenzotriazole (HOBT) [Formula IV]. Other compounds which can be used as activating compounds include 2-hydroxypyridine-N-oxide (HOPO), 2-hydroxypyridine and 1-hydroxysuccinimide.

The amines of the formula HNR^{c}R^{d} are well known to a practioner of this art and are obtainable either commercially or by modification of known synthetic techniques, such as those found in “Organic Synthesis”, a source that is well-known and used by a practitioner in the field. Preferred aminos include, for example, amines wherein R^{c} is H and R^{d} is selected from the group consisting of:

H, CH₃, CH₂CH₃, C(CH₃)₃, CH₂CH₂CH₃, CH₂CH₂OH, CH(CO₂CH₃)CH₂OH, CH₂CO₂CH₃, CH₂CH(OCH₂CH₃)₂, CH₂CH₂OCH₂CH₂OH, CH(CH₃)(CH₂)₃C(CH₃)₂OH, (CH₂)₃OH, (CH₂)₄OH, (CH₂)SOH, CH(CH₂OH)CH₂CH₃, NHC(CH₃)₃, CH₂CN, (CH₂)₆OH, CH₂CH(OH)CH₃, CH(CH₂OH)CH₂CH₂CH₃, CH₂CH₂SCH₃, CH₂CH₂SCH₂CH₃, CH₂CONH₂, CH(CH₃)(CH₂OH)₂, CH₂CH₂NHCH₂CH₂OH, CH(CH₂OH)(CH₂)₃CH₃, CH(CH₂OCH₃)CH₃, (CH₂)₂SH, (CH₂)₄NH₂, CH₂CH₂SO₂CH₃, CH₂CH₂S(O)CH₃, CH(CH(CH₃)₂)CH₂OH, (CH₂)₃NH₂, (CH₂)₃N(CH₂CH₃)₂, (CH₂)₃N(CH₃)₂, OCH₂CH₃, CH₂CH(OH)CH₂OH, OCH₃, CH₂CH₂OCH₃, CH₂CH₂NHC(O)CH₃, C(CH₃)₂CH₂OH, c-C₃H₅, cC₆H₁₁, (CH₂)₃OCH₂CH₃, CH₂CH═CH₂, C(CH₂CH₃)(CH₂OH)₂, CH₂C≡CH, CH₂CO₂CH₂CH₃, CH₂CH₂F, (CH₂)₃O(CH₂)₁₁CH₃, CH₂CH₂N(CH₃)₂, CH₂CH₂OCH₂CH₂NH₂, CH₂CF₃, NHCH₂CO₂CH₂CH₃, CH(CH₃)CO₂CH₃, C(CH₃)₂CH₂C(O)CH₃, CH(CO₂CH₂CH₃)₂, CH₂CH₃, CH(CH₂CH₂CH₃)CO₂CH₃, CH₂CH₂CH₂OCH₃, C(CH₃)₂CH₂C≡CH, (CH₂)₄CH₃, CH(CH₂CH₂CH₃)₂, (CH₂)SCH₃, CH₂CH₂CO₂H, CH(CH(CH₃)₂)CO₂CH₃, OCH₂CO₂H, CH(CH(CH₃)₂)CH₂OH, CH(CH(CH₃)₂)CH₂OH, CH(CH₃)CH₂OH, CH(CH₃)CH₂OH, CH(CH₃)₂, C(CH₃)₃, (CH₂)CH(CH₃)₂, CH(CH₃)CH₂CH₃, CH₂CH(CH₃)OH, (CH₂)₃CH₃, (CH₂)₂OCH₂CH₃, 1-adamantyl, (CH₂)₈CH₃, CH(CH₃)CH(CH₃)₂, (CH₂)₃NHCH₃, (CH₂)₂N(CH₂CH₃)₂,

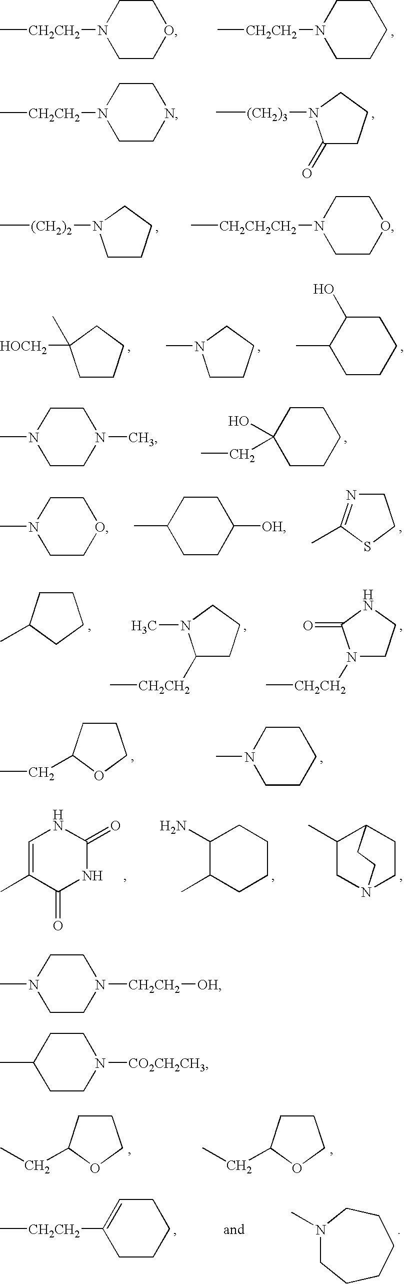

Preferred solvents for this reaction include halogenated hydrocarbons, such as dichloromethane and ethylene chloride, ethers, such as methyl t-butyl ether (MTBE), diethyl ether or tetraydrofuran (THF), or mixtures of the foregoing. Other solvents include polar aprotic solvents including but not limited to dimethoxymethane, 2-methyltetrahydrofuran, methyl iso-butylketone, benzotrifuoride and methylacetate. Perferably, the inventive process uses a homogeneous solvent system that dissolves both the nodulisporic acid derivatives and the activation agents and avoids the prior process, which perform the activating/coupling reaction two phase water-organic solvent system, thereby permitting the reaction to run faster and obtain conversion more easily. A mixture of MTBE and THF is especially preferred. Preferred ranges of MTBE to THF are about 5:1 to about 1:2, with about 4:1 to about 2:3 being especially preferred.

The amount of DCC and HOBT should be in molar excess to achieve full conversion. A preferred range would be from about 1.1 to about 2.5, with about 1.2 to about 1.8 equivalents being especially preferred.

Reaction temperatures range from about 10° C. to about 50° C. with about 20° C. to about 30° C. being especially preferred.

Optionally, the nodulisporamide derivative may be recrystallized to obtain a product with better purity. Suitable recrystallization solvents include a mixture of a polar solvent such as water, acetonitrile, acetone and an apolar solvent such as alkanes and cycloalkanes including but not limited to pentane, hexane, cyclohepatane, cyclohexane, cyclohepatane. Preferred mixture of recrystallization solvent include acetone/heptane with few drops of water. An especially preferred mixture of solvents include first optionally recrystallizing from acetonitrile/water followed by acetone/heptane.

Compounds of formula V′ are also novel and are part of this invention.

Administration of the inventive formulation may be intermittent in time and may be administered daily, weekly, biweekly, monthly, bimonthly, quarterly, or even for longer durations of time. The time period between treatments depends upon factors such as the parasite(s) being treated, the degree of infestation, the type of mammal or bird and the environment where it resides. It is well within the skill level of the practitioner to determine a specific administration period for a particular situation. This invention contemplates a method for permanently combating a parasite in an environment in which the animal is subjected to strong parasitic pressure where the administration is at a frequency far below a daily administration in this case. For example, it is preferable for the treatment according to the invention to be carried out monthly on dogs and on cats.

Spot-on formulations may be prepared by dissolving the active ingredients into the pharmaceutically or veterinary acceptable vehicle. Alternatively, the spot-on formulation can be prepared by encapsulation of the active ingredient to leave a residue of the therapeutic agent on the surface of the animal. These formulations will vary with regard to the weight of the therapeutic agent in the combination depending on the species of host animal to be treated, the severity and type of infection and the body weight of the host. The compounds may be administered continuously, particularly for prophylaxis, by known methods.

Generally, a dose of from about 0.001 to about 100 mg per kg of body weight, with a range of 0.25 to 50 mg/kg being especially preferred, given as a single dose or in divided doses for a period of from about 1 to about 60 days, preferably from about 1 to 30 days, will be satisfactory but, of course, there can be instance where higher or lower dosage ranges are indicated and such are within the scope of this invention. It is well within the routine skill of the practitioner to determine a particular dosing regimen for a specific host and parasite.

It also may be preferable to use controlled-release formulations.

The invention also relates to such a method with a therapeutic aim intended for the treatment and prevention of parasitoses having pathogenic consequences.

This invention also provides for formulations wherein the nodulisporic acid or derivative thereof is combined with a second active agent, such a parasiticide. Examples of classes of these compounds include avermectins, milbemycins, 1-N-arylpyrazoles, IGR compounds, etc., some of which are discussed above.

The formulations of the present invention provide for the topical administration of a concentrated solution, suspension, microemulsion or emulsion for intermittent application to a spot on the animal, generally between the two shoulders. It has been discovered that the inventive formulations are especially active against parasites when the formulations are applied to mammals and birds, especially poultry, dogs, cats, sheep, pigs, cattle and horses. These formulations comprise a composition of an effective amount of at least one nodulisporic acid derivative dissolved in a pharmaceutical or veterinary acceptable carrier vehicle where a crystallization inhibitor is optionally present. The nodulisporic acid derivative are advantageously resent in the inventive formulation in a proportion of about 1 to about 40%, preferably of about 1 to about 30% and most preferably about 5 to about 15% (percentages as weight by volume=W/V). The liquid carrier vehicle comprises a pharmaceutically or veterinary acceptable organic solvent and optionally an organic cosolvent.

Also contemplated are the pharmaceutically or veterinary acceptable acid or base salts, where applicable, of the active compounds provided for herein. The term “acid” contemplates all pharmaceutically or veterinary acceptable inorganic or organic acids. Inorganic acids include mineral acids such as hydrohalic acids, such as hydrobromic and hydrochloric acids, sulfuric acids, phosphoric acids and nitric acids. Organic acids include all pharmaceutically or veterinary acceptable aliphatic, alicyclic and aromatic carboxylic acids, dicarboxylic acids tricarboxylic acids and fatty acids. Preferred acids are straight chain or branched, saturated or unsaturated C₁-C₂₀ aliphatic carboxylic acids, which are optionally substituted by halogen or by hydroxyl groups, or C₆-C₁₂ aromatic carboxylic acids. Examples of such acids are carbonic acid, formic acid, fumaric acid, acetic acid, propionic acid, isopropionic acid, valeric acid, α-hydroxy acids, such as glycolic acid and lactic acid, chloroacetic acid, benzoic acid, methane sulfonic acid, and salicylic acid. Examples of dicarboxylic acids include oxalic acid, malic acid, succinic acid, tartaric acid and maleic acid. An example of a tricarboxylic acid is citric acid. Fatty acids include all pharmaceutically or veterinary acceptable saturated or unsaturated aliphatic or aromatic carboxylic acids having 4 to 24 carbon atoms. Examples include butyric acid, isobutyric acid, sec-butyric acid, lauric acid, palmitic acid, stearic acid, oleic acid, linoleic acid, linolenic acid, and phenylsteric acid. Other acids include gluconic acid, glycoheptonic acid and lactobionic acid.

The term “base” contemplates all pharmaceutically or veterinary acceptable inorganic or organic bases. Such bases include, for example, the alkali metal and alkaline earth metal salts, such as the lithium, sodium, potassium, magnesium or calcium salts. Organic bases include the common hydrocarbyl and heterocyclic amine salts, which include, for example, the morpholine and piperidine salts.

The organic solvent for the liquid carrier vehicle will preferably have a dielectric constant of between about 10 and about 35, preferably between about 20 and about 30, the content of this solvent in the overall composition preferably representing the remainder to 100% of the composition. It is well within the skill level of the practitioner to select a suitable solvent on the basis of these parameters.

The organic cosolvent for the liquid carrier vehicle will preferably have a boiling point of less than about 100° C., preferably of less than about 80° C., and will have a dielectric constant of between about 10 and about 40, preferably between about 20 and about 30; this cosolvent can advantageously be present in the composition according to a weight/weight (W/W) ratio with respect to the solvent of between about 1/15 and about 1/2; the cosolvent is volatile in order to act in particular as drying promoter and is miscible with water and/or with the solvent. Again, it is well within the skill level of the practitioner to select a suitable solvent on the basis of these parameters.

The organic solvent for the liquid carrier includes the commonly acceptable organic solvents known in the formulation art. These solvents may be found, for example, in Remington Pharmaceutical Science, 16^{th} Edition (1986). These solvents include, for example, acetone, ethyl acetate, methanol, ethanol, isopropanol, dimethylformamide, dichloromethane or diethylene glycol monoethyl ether (Transcutol). These solvents can be supplemented by various excipients according to the nature of the desired phases, such as C₈-C₁₀ caprylic/capric triglyceride (Estasan or Miglyol 812), oleic acid or propylene glycol.

The liquid carrier may also comprise a microemulsion. Microemulsions are also well suited as the liquid carrier vehicle. Microemulsions are quaternary systems comprising an aqueous phase, an oily phase, a surfactant and a cosurfactant. They are translucent and isotropic liquids.

Microemulsions are composed of stable dispersions of microdroplets of the aqueous phase in the oily phase or conversely of microdroplets of the oily phase in the aqueous phase. The size of these microdroplets is less than 200 nm (1000 to 100,000 nm for emulsions). The interfacial film is composed of an alternation of surface-active (SA) and co-surface-active (Co-SA) molecules which, by lowering the interfacial tension, allows the microemulsion to be formed spontaneously.

The oily phase can in particular be formed from mineral or vegetable oils, from unsaturated polyglycosylated glycerides or from triglycerides, or alternatively from mixtures of such compounds. The oily phase preferably comprises triglycerides and more preferably medium-chain triglycerides, for example C₈-C₁₀ caprylic/capric triglyceride. The oily phase will represent, in particular, from about 2 to about 15%, more particularly from about 7 to about 10%, preferably from about 8 to about 9%, V/V of the microemulsion.

The aqueous phase includes, for example water or glycol derivatives, such as propylene glycol, glycol ethers, polyethylene glycols or glycerol. Propylene glycol, diethylene glycol monoethyl ether and dipropylene glycol monoethyl ether are especially preferred. Generally, the aqueous phase will represent a proportion from about 1 to about 4% V/V in the microemulsion.

Surfactants for the microemulsion include diethylene glycol monoethyl ether, dipropyelene glycol monomethyl ether, polyglycolysed C₈-C₁₀ glycerides or polyglyceryl-6 dioleate. In addition to these surfactants, the cosurfactants include short-chain alcohols, such as ethanol and propanol.

Some compounds are common to the three components discussed above, i.e., aqueous phase, surfactant and cosurfactant. However, it is well within the skill level of the practitioner to use different compounds for each component of the same formulation.

The cosurfactant to surfactant ratio will preferably be from about 1/7 to about 1/2. There will preferably be from about 25 to about 75% V/V of surfactant and from about 10 to about 55% V/V of cosurfactant in the microemulsion.

Likewise, the co-solvents are also well known to a practitioner in the formulation art. Preferred co-solvents are those which is a promoter of drying and include, for example, absolute ethanol, isopropanol (2-propanol) or methanol.

If present, it is preferred that the crystallization inhibitor is present in a proportion of about 1 to about 20% (W/V), preferably of about 5 to about 15%. The inhibitor preferably corresponds to the test in which 0.3 ml of a solution comprising 10% (W/V) of the compound of formula (1) in the liquid carrier and 10% of the inhibitor are deposited on a glass slide at 20° C. and allowed to stand for 24 hours. The slide is then observed with the naked eye. Acceptable inhibitors are those whose addition provides for few or no crystals, and in particular less than 10 crystals, preferably 0 crystals.

Although this is not preferred, the formulation can optionally comprise water, in particular in a proportion of 0 to about 30% (volume by volume V/V), in particular of 0 to about 5%.

The formulation can also comprise an antioxidizing agent intended to inhibit oxidation in air, this agent being in particular present in a proportion of about 0.005 to about 1% (W/V), preferably of about 0.01 to about 0.05%.

Crystallization inhibitors which can be used in the invention include:

polyvinylpyrrolidone, polyvinyl alcohols, copolymers of vinyl acetate and of vinylpyrrolidone, polyethylene glycols, benzyl alcohol, mannitol, glycerol, sorbitol or polyoxyethylenated esters of sorbitan; lecithin or sodium carboxymethylcellulose; or acrylic derivatives, such as methacrylates and others,

anionic surfactants, such as alkaline stearates, in particular sodium, potassium or ammonium stearate; calcium stearate or triethanolamine stearate; sodium abietate; alkyl sulphates, in particular sodium lauryl sulphate and sodium cetyl sulphate; sodium dodecylbenzenesulphonate or sodium dioctyl sulphosuccinate; or fatty acids, in particular those derived from coconut oil,

cationic surfactants, such as water-soluble quaternary ammonium salts of formula N⁺R′R″R′″R″″Y⁻, in which the R radicals are identical or different optionally hydroxylated hydrocarbon radicals and Y⁻ is an anion of a strong acid, such as halide, sulphate and sulphonate anions; cetyltrimethylammonium bromide is one of the cationic surfactants which can be used,

amine salts of formula N⁺R′R″R′″, in which the R radicals are identical or different optionally hydroxylated hydrocarbon radicals; octadecylamine hydrochloride is one of the cationic surfactants which can be used,

non-ionic surfactants, such as optionally polyoxyethylenated esters of sorbitan, in particular Polysorbate 80, or polyoxyethylenated alkyl ethers; polyethylene glycol stearate, polyoxyethylenated derivatives of castor oil, polyglycerol esters, polyoxyethylenated fatty alcohols, polyoxyethylenated fatty acids or copolymers of ethylene oxide and of propylene oxide,

amphoteric surfactants, such as substituted lauryl compounds of betaine,

or preferably a mixture of at least two of the compounds listed above.

In a particularly preferred embodiment, a crystallization inhibitor pair will be used. Such pairs include, for example, the combination of a film-forming agent of polymeric type and of a surface-active agent. These agents will be selected in particular from the compounds mentioned above as crystallization inhibitor.

Particularly preferred film-forming agents of polymeric type include:

the various grades of polyvinylpyrrolidone,

polyvinyl alcohols, and

copolymers of vinyl acetate and of vinylpyrrolidone.

Especially preferred surface-active agents, include those made of non-ionic surfactants, preferably polyoxyethylenated esters of sorbitan and in particular the various grades of polysorbate, for example Polysorbate 80.

The film-forming agent and the surface-active agent can in particular be incorporated in similar or identical amounts within the limit of the total amounts of crystallization inhibitor mentioned elsewhere.

The pair thus constituted secures, in a noteworthy way, the objectives of absence of crystallization on the coat and of maintenance of the cosmetic appearance of the fur, that is to say without a tendency towards sticking or towards a sticky appearance, despite the high concentration of active material.

Particularly preferred antioxidizing agents are those conventional in the art and include, for example, butylated hydroxyanisole, butylated hydroxytoluene, ascorbic acid, sodium metabisulphite, propyl gallate, sodium thiosulphate or a mixture of not more than two of them.

The formulation adjuvants discussed above are well known to the practitioner in this art and may be obtained commercially or through known techniques. These concentrated compositions are generally prepared by simple mixing of the constituents as defined above; advantageously, the starting point is to mix the active material in the main solvent and then the other ingredients or adjuvants are added.

The volume applied can be of the order of about 0.3 to about 1 ml, preferably of the order of about 0.5 ml, for cats and of the order of about 0.3 to about 5 ml for dogs, depending on the weight of the animal.

The formulations according to the invention are extremely effective for long durations of time in the treatment of parasites such as fleas of mammals and, in particular, of small mammals such as dogs and cats. The inventive formulations exhibit a degree of effectiveness against other parasitic insects and in particular fleas and ticks. The inventive formulations further exhibit synergy when treating infestations cause by ectoparasites and endoparasites.

Other advantages and characteristics of the invention will become apparent on reading the following description, given by way of non-limiting examples.

### EXAMPLES

### Example 1

### Topical Spot-On Formulation (20% w/v t-butyl Nodulisporamide)

A spot-on formulation comprising the following ingredients was prepared by mixing the following ingredients

| Component | Amount (% w/v) |
|---|---|
| t-butyl nodulisporamide | 20 |
| Tenox 2 (antioxidant) | 0.02 |
| Transcutol (carrier) | 100 qs |

### Example 2

### Topical Spot-On Formulation (10% w/v t-butyl Nodulisporamide)

A spot-on formulation comprising t-butyl nodulisporamide was prepared by moving the following ingredients

| Ingredient | Amount (% w/v) |
|---|---|
| t-butyl nodulisporamide | 10 |
| Tenox 2 (antioxidant) | 0.02 |
| Miglyol 840 (additive) | 10 |
| Povidone (crystallization inhibitor) | 5 |
| Transcotol (liquid carrier) | 100 qs |

### Example 3

### Long Term Efficacy

The spot-on formulation according to Example 1 was applied to four dogs infested with fleas for a thirty-five day period. The results are summarized below

| Day | 1 | 7 | 14 | 21 | 28 | 35 |
|---|---|---|---|---|---|---|
| % effic | 100 | 99.7 | 100 | 99.6 | 89.3 | 71.8 |

The data demonstrate that the spot-on formulation retained its efficacy for the thirty-five day period.

### Example 4

### Long Term Efficacy

The spot-on formulation according to the first Example 1 (40 mg/kg) was applied to four cats infested with fleas and its efficacy for thirty-five days was measured. The results are summarized below

| Day | 1 | 7 | 14 | 21 | 28 | 35 |
|---|---|---|---|---|---|---|
| % effic | 100 | 100 | 100 | 100 | 100 | 99.2 |

The data demonstrate that the spot-on formulation retained its efficacy for the thirty-five day period.

### Example 5

### Synthesis of t-butyl Nodulisporamide

A reactor fitted with a stirrer was charged with 4.8 L of MTBE and 1.2 L of THF. Stirring was started and after mixing, 1.11 kg (1.5 mol) of nodulisporic acid A, used as a solvate prepared by crystallizing nodulisporic acid A from methanol and acetonitrite in a molar ratio of 1:1:1, was added to the to the reactor and allowed to dissolve. Next, 0.26 kg HOBT.H₂O (1,70 mol) was charged to the reactor followed by the addition of 0.35 kg of a melt of DCC (1,70 mol) over a period of 1.5 h, keeping the temperature of the reaction between 20-30° C.

The mixture was then stirred for 4 h at 20-30° C. Following this, 0.27 kg of TBA (3.69 mol) was added over a period of 1 h, again keeping the temperature of the reaction between 20-30° C. The mixture was then stirred for 1 h at 20-30° C.

Following stirring, the reaction mixture was filtered over filter cloth (Dralon) and the cake was washed with 4:1 (v/v) MTBE/THF (3×1.0 L) by means of a passive wash. The cake (DCU) is collected as solid organic waste (0.28 kg dry weight).

The filtrates were combined and washed sequentially with 5.0 L of 0.5 N aqueous hydrochloric acid and 5.0 L of aqueous saturated sodium bicarbonate. The washed filtrate (MTBE/THF) was concentrated in vacuo (30° C., 50-100 mBar) to ca. 6.0 L.

6.0 L of acetonitrile was added and the solution was concentrated in vacuo to 3.6 L. Water (2.4 L) was then added with stirring to the acetonitrile solution over a period of 2 h at 20-25° C. A yellow precipitate formed and this was filtered over filter cloth (Dralon) and then washed with acetonitrile/water (3:2 v/v) (2×1.5L). The solid was then air-dried for 3 h at ambient temperature and then in vacuo at 40-45° C. to constant weight. The crude t-butyl nodulisporamide was subsequently recrystallized from acetone/heptane by first dissolving the crude t-butyl nodulisporamide in 2.5 L of acetone and then adding 5.8 L of heptane over a 2 h period of time with mechanical stirring at a temperature 20-25° C. The mixture was then aged for 2 h at 20° C.

The slurry was filtered over filter cloth and the cake sequentially washed with 1:4 (v/v) acetone/heptane (2×1.5L) and heptane (3.0L). The cake was air-dried for 3 h at ambient temperature and then under vacuum at 40-45° C. to constant weight to give a molar yield of 75% of t-butyl nodulisporamide based upon nodulisporic acid A.

The above description of the invention is intended to be illustrative and not limiting. Various changes or modifications in the embodiments described herein may occur to those skilled in the art. These can be made without departing from the scope and spirit of the invention.

What is claimed:

1. A spot-on formulation for the treatment or prophylaxis of parasite infestation in mammals or birds which comprises
(1) an effective amount of at least one nodulisporic acid derivative
(2) a pharmaceutically or veterinary acceptable liquid carrier vehicle; and
(3) optionally, a crystallization inhibitor.

2. The spot-on formulation according to claim 1, which comprises:
(1) an effective amount of at least one nodulisporic acid derivative of the formula: 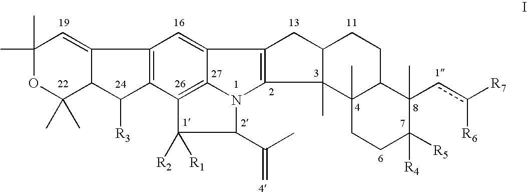
wherein
R₁ is (1) hydrogen,
(2) optionally substituted alkyl,
(3) optionally substituted alkenyl,
(4) optionally substituted alkynyl,
(5) optionally substituted cycloalkyl,
(6) optionally substituted cycloalkenyl,
where the substituents on the alkyl, alkenyl, alkynyl, cycloalkyl and cycloalkenyl are 1 to 3 groups independently selected from
(i) alkyl,
(ii) X-alkyl, where X is O or S(O)ₘ,
(iii) cycloalkyl,
(iv) hydroxy,
(v) halogen,
(vi) cyano,
(vii) carboxy,
(viii) NY¹Y², where Y¹ and Y² are independently H or alkyl,
(ix) alkanoylamino, and
(x) aroylamino wherein said aroyl is optionally substituted with 1 to 3 groups independently selected from R^{f},
(7) aryl or arylalkyl wherein said aryl is optionally substituted with 1 to 3 groups independently selected from R^{f},
(8) perfluoroalkyl
(9) a 5- or 6-member heterocycle containing from 1 to 4 heteroatoms independently selected from oxygen, sulfur and nitrogen atoms optionally substituted by 1 to 3 groups independently selected from hydroxy, oxo, alkyl and halogen, and which may be saturated or partly unsaturated,
R₂, R₃, and R₄ are independently OR^{a}, OCO₂R^{b}, OC(O)NR^{c}R^{d}; or
R₁ and R₂ together represent ═O, ═NOR^{a} or ═N—NR^{c}R^{d};
R₅ and R₆ are H; or
R₅ and R₆ together represent —O—;
R₇ is (1) CHO, or
(2), the fragment 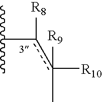
R₈ is (1) H,
(2) OR^{a}, or
(3) NR^{c}R^{d}
R₉ is (1) H, or
(2) OR^{a};
R₁₀ is (1) CN,
(2) C(O)OR^{b},
(3) C(O)N(OR^{b})R^{c},
(4) C(O)NR^{c}R^{d},
(5) NHC(O)OR^{b},
(6) NHC(O)NR^{c}R^{d},
(7) CH₂OR^{a},
(8) CH₂OCO₂R^{b},
(9) CH₂OC(O)NR^{c}R^{d},
(10) C(O)NRCNR^{c}R^{d}, or
(11) C(O)NR^{c}SO₂R^{b}; [symbol]
represents a single or a double bond;
R^{a} is (1) hydrogen,
(2) optionally substituted alkyl,
(3) optionally substituted alkenyl,
(4) optionally substituted alkynyl,
(5) optionally substituted alkanoyl,
(6) optionally substituted alkenoyl,
(7) optionally substituted alkynoyl,
(8) optionally substituted aroyl,
(9) optionally substituted aryl,
(10) optionally substituted cycloalkanoyl,
(11) optionally substituted cycloalkenoyl,
(12) optionally substituted alkylsulfonyl
(13) optionally substituted cycloalkyl
(14) optionally substituted cycloalkenyl
where the substituents on the alkyl, alkenyl, alkynyl, alkanoyl, alkenoyl, alkynoyl, aroyl, aryl, cycloalkanoyl, cycloalkenoyl, alkylsulfonyl, cycloalkyl and cycloalkenyl are from 1 to 10 groups independently selected from the group consisting of hydroxy, alkoxy, cycloalkyl, aryl alkoxy, NR^{g}R^{h}, CO₂R_{b}, CONR^{c}R^{d} and halogen,
(15) perfluoroalkyl,
(16) arylsulfonyl optionally substituted with 1 to 3 groups independently selected from alkyl, perfluoroalkyl, nitro, halogen and cyano,
(17) a 5- or 6-member heterocycle containing 1 to 4 heteroatoms selected from oxygen, sulfur and nitrogen optionally substituted by 1 to 4 groups independently selected from alkyl, alkenyl, perfluoroalkyl, amino, C(O)NR^{c}R^{d}, cyano, CO₂R^{b} and halogen, and which may be saturated or partly unsaturated;
R^{b} is (1) H,
(2) optionally substituted aryl,
(3) optionally substituted alkyl,
(4) optionally substituted alkenyl,
(5) optionally substituted alkynyl,
(6) optionally substituted cycloalkyl,
(7) optionally substituted cycloalkenyl, or
(8) optionally substituted heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups independently selected from
(i) hydroxy,
(ii) alkyl,
(iii) oxo,
(iv) SO₂NR^{g}R^{h}
(v) arylalkoxy,
(vi) hydroxyalkyl,
(vii) alkoxy,
(viii) hydroxyalkoxy,
(ix) aminoalkoxy,
(x) cyano,
(xi) mercapto,
(xii) alkyl-S(O)ₘ,
(xiii) cycloalkyl optionally substituted
with 1 to 4 groups independently selected from R^{e},
(xiv) cycloalkenyl,
(xv) halogen,
(xvi) alkanoyloxy,
(xvii) C(O)NR^{g}R^{h},
(xviii) CO₂Rⁱ,
(xix) formyl,
(xx) —NR^{g}R^{h},
(xxi) 5 to 9-member heterocycle, which may be saturated or partially unsaturated, containing from 1 to 4 heteroatoms independently selected from oxygen, sulfur and nitrogen, and optionally substituted with 1 to 5 groups independently selected from R^{e},
(xxii) optionally substituted aryl, wherein the aryl substituents are 1,2-methylenedioxy or 1 to 5 groups independently selected from R^{e},
(xxiii) optionally substituted arylalkoxy, wherein the aryl substituents are 1,2-methylenedioxy or 1 to 5 groups independently selected from R^{e}, and
(xxiv) perfluoroalkyl;
R^{c} and R^{d} are independently selected from R^{b}; or
R^{c} and R^{d} together with the N to which they are attached form a 3- to 10-member ring containing 0 to 2 additional heteroatoms selected from O, S(O)ₘ, and N, optionally substituted with 1 to 3 groups independently selected from R^{g}, hydroxy, thioxo and oxo;
R^{e} is (1) halogen,
(2) alkyl,
(3) perfluoroalkyl,
(4) —S(O)ₘRⁱ,
(5) cyano,
(6) nitro,
(7) RⁱO(CH₂)ᵥ—,
(8) RⁱCO₂(CH₂)ᵥ—,
(9) RⁱOCO(CH₂)ᵥ—,
(10) optionally substituted aryl where the substituents are from 1 to 3 of halogen, alkyl, alkoxy, or hydroxy,
(11) SO₂NR^{g}R^{h}, or
(12) amino;
R^{f} is (1) alkyl,
(2) X-alkyl, where X is O or S(O)ₘ,
(3) alkenyl,
(4) alkynyl,
(5) perfluoroalkyl,
(6) NY¹Y², where Y¹ and Y² are independently H or alkyl,
(7) hydroxy,
(8) halogen, and
(9) alkanoyl amino,
R^{g} and R^{h} are independently
(1) hydrogen,
(2) alkyl optionally substituted with hydroxy, amino, or CO₂Rⁱ
(3) aryl optionally substituted with halogen, 1,2-methylenedioxy, alkoxy, alkyl or perfluoroalkyl,
(4) arylalkyl, wherein the aryl is optionally substituted with perfluorolkyl or 1,2-methylenedioxy;
(5) alkoxycarbonyl,
(6) alkanoyl,
(7) alkanoylalkyl,
(9) arylalkoxycarbonyl,
(10) aminocarbonyl,
(11) monoalkylaminocarbonyl
(12) dialkylaminocarbonyl; or
R^{g} and R^{h} together with the N to which they are attached form a 3- to 7-member ring containing 0 to 2 additional heteroatoms selected from O, S(O)ₘ, and N, optionally substituted with 1 to 3 groups independently selected from R^{e} and oxo;
Rⁱ is (1) hydrogen,
(2) perfluoroalkyl,
(3) alkyl,
(4) optionally substituted aryl, or arylalkyl, where the aryl substituents are from 1 to 3 groups independently selected from halogen, alkyl, alkoxy, and hydroxy;
m is 0 to 2; and
v is 0 to 3; or
a pharmaceutically acceptable salt thereof;
(2) a liquid carrier vehicle comprising a solvent and optionally a cosolvent wherein the solvent is selected from the group consisting of acetone, acetonitrile, benzyl alcohol, butyl diglycol, dimethylacetamide, dimethylformamide, dipropylene glycol n-butyl ether, ethanol, isopropanol, methanol, diethylene glycol monoethyl ether, ethylene glycol monomethyl ether, monomethylaceamide, dipropylene glycol monomethyl ether, liquid polyoxyethylene glycols, propylene glycol, 2-pyrrolidone, diethylene glycol monoethyl ether, ethylene glycol, diethyl phthalate, and a mixture of at least two of these solvents and the cosolvent is selected from the group consisting of absolute ethanol, isopropanol or methanol;
(3) optionally, a crystallization inhibitor selected from the group consisting of an anionic surfactant, a cationic surfactant, a non-ionic surfactant, an amine salt, an amphoteric surfactant, polyvinylpyrrolidone, polyvinyl alcohols, copolymers of vinyl acetate and vinylpyrrolidone, polyethylene glycols, benzyl alcohol, mannitol, glycerol, sorbitol, polyoxyethylenated sorbitan esters; lecithin, sodium carboxymethylcellulose, and acrylic derivatives, or a mixture of these crystallization inhibitors.

3. The spot-on formulation according to claim 2 wherein
R₁ is (1) hydrogen,
(2) optionally substituted alkyl,
(3) optionally substituted alkenyl,
(4) optionally substituted alkynyl,
(5) optionally substituted cycloalkyl,
(6) optionally substituted cycloalkenyl where the substituents on the alkyl, alkenyl, alkynyl, cycloalkyl and cycloalkenyl are 1 to 3 groups independently selected from
(i) alkyl,
(ii) X-alkyl, where X is O or S(O)ₘ,
(iii) cycloalkyl,
(iv) hydroxy,
(v) halogen,
(vi) cyano,
(vii) carboxy, and
(viii) NY¹Y², where Y¹ and Y² are independently H or alkyl,
(7) aryl alkyl wherein said aryl is optionally substituted with 1 to 3 groups independently selected from R^{f},
(8) perfluoroalkyl,
(9) a 5- or 6-member heterocycle containing from 1 to 4 heteroatoms independently selected from oxygen, sulfur and nitrogen atoms optionally substituted by 1 to 3 groups independently selected from hydroxy, oxo, alkyl and halogen, and which may be saturated or partly unsaturated,
R₈ is (1) H,
(2) OH, or
(3) NH₂;
R₉ is (1) H or
(2) OH;
R₁₀ is (1) C(O)OR^{b},
(2) C(O)N(OR^{b})R^{c},
(3) C(O)NR^{c}R^{d},
(4) NHC(O)OR^{b},
(5) NHC(O)NR^{c}R^{d},
(6) CH₂OR^{a},
(7) CH₂OCO₂R^{b},
(8) CH₂OC(O)NR^{c}R^{d},
(9) C(O)NR^{c}NR^{c}R^{d}, or
(10) C(O)NR^{c}SO₂R^{b};
R^{a} is (1) hydrogen,
(2) optionally alkyl,
(3) optionally substituted alkenyl,
(4) optionally substituted alkynyl,
(5) optionally substituted alkanoyl,
(6) optionally substituted alkenoyl,
(7) optionally substituted alkynoyl,
(8) optionally substituted aroyl,
(9) optionally substituted aryl,
(10) optionally substituted cycloalkanoyl,
(11) optionally substituted cycloalkenoyl,
(12) optionally substituted alkylsulfonyl
(13) optionally substituted cycloalkyl
(14) optionally substituted cycloalkenyl where the substituents on the alkyl, alkenyl, alkynyl, alkanoyl, alkenoyl, alkynoyl, aroyl, aryl, cycloalkanoyl, cycloalkenoyl, alkylsulfonyl, cycloalkyl and cycloalkenyl are from 1 to 10 groups independently selected from hydroxy, alkoxy, cycloalkyl, aryl alkoxy, NR^{g}R^{h}, CO₂R^{b}, CONR^{c}R^{d} and halogen,
(15) perfluoroalkyl,
(16) arylsulfonyl optionally substituted with 1 to 3 groups independently selected from alkyl, perfluoroalkyl, halogen and cyano,
(17) a 5- or 6-member heterocycle containing 1 to 4 heteroatoms selected from oxygen, sulfur and nitrogen optionally substituted by 1 to 4 groups independently selected from alkyl, alkenyl, perfluoroalkyl, amino, C(O)NR^{c}R^{d}, cyano, CO₂R^{b} and halogen, and which may be saturated or partly unsaturated;
R^{b} is (1) H,
(2) optionally substituted aryl,
(3) optionally substituted alkyl,
(4) optionally substituted alkenyl,
(5) optionally substituted alkynyl,
(6) optionally substituted cycloalkyl,
(7) optionally substituted cycloalkenyl, or
(8) optionally substituted 5- to 10-member heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups independently selected from
(i) hydroxy,
(ii) alkyl,
(iii) oxo,
(iv) SO₂NR^{g}R^{h},
(v) arylalkoxy,
(vi) hydroxyalkyl,
(vii) alkoxy,
(viii) hydroxyalkoxy,
(ix) aminoalkoxy,
(x) cyano,
(xi) perfluoroalkyl,
(xii) alkyl-S(O)ₘ,
(xiii) cycloalkyl optionally substituted
with 1 to 4 groups independently selected from R^{e},
(xiv) cycloalkenyl,
(xv) halogen,
(xvi) alkanoyloxy,
(xvii) C(O)NR^{g}R^{h},
(xviii) CO₂Rⁱ,
(xix) optionally substituted aryl alkoxy,
wherein the aryl substituents are 1,2-methylenedioxy or 1 to 5 groups independently selected from R^{e},
(xx) —NR^{g}R^{h},
(xxi) 5 to 6-member heterocycle, which may be saturated or partially unsaturated, containing from 1 to 4 heteroatoms independently selected from oxygen, sulfur and nitrogen, and optionally substituted with 1 to 5 groups independently selected from R^{e}, and
(xxii) optionally substituted aryl, wherein the aryl substituents are 1,2-methylenedioxy or 1 to 5 groups independently selected from Re;
R^{e} is (1) halogen,
(2) alkyl,
(3) perfluoroalkyl,
(4) —S(O)ₘRⁱ,
(5) cyano,
(6) amino,
(7) RⁱO(CH₂)^{v}—,
(8) RⁱCO₂(CH₂)^{v}—,
(9) RⁱOCO(CH₂)ᵥ—,
(10) optionally substituted aryl where the substituents are from 1 to 3 of halogen, alkyl, alkoxy, or hydroxy, or
(11) SO₂NR^{g}R^{h};
R^{f} is (1) methyl,
(2) X-alkyl, where X is O or S(O)^{m},
(3) halogen,
(4) acetylamino,
(5) trifluoromethyl,
(6) NY¹Y², where Y¹ and Y² are independently H or methyl, and
(7) hydroxy;
R^{g} and R^{h} are independently
(1) hydrogen,
(2) alkyl optionally substituted with hydroxy, amino, or CO₂Rⁱ
(3) aryl optionally substituted with halogen, 1,2-methylenedioxy, alkoxy, alkyl or perfluoroalkyl,
(4) aryl alkyl, wherein the aryl is optionally substituted with perfluorolkyl or 1,2-methylenedioxy;
(5) alkoxycarbonyl,
(6) alkanoyl,
(7) alkanoylalkyl,
(9) arylalkoxycarbonyl,
(10) aminocarbonyl,
(11) monoalkylaminocarbonyl
(12) dialkylaminocarbonyl; or
R^{g} and R^{h} together with the N to which they are attached form a 5- to 6 membered ring containing 0 to 2 additional heteroatoms selected from O, S(O)ₘ, and N, optionally substituted with 1 to 3 groups independently selected from R^{e} and oxo;
Rⁱ is (1) hydrogen,
(2) perfluoroalkyl,
(3) alkyl,
(4) optionally substituted aryl alkyl, where the aryl substituents are from 1 to 3 groups independently selected from halogen, alkyl, alkoxy, and hydroxy.

4. The spot-on formulation according to claim 2, wherein
R¹ is (1) hydrogen,
(2) optionally substituted alkyl,
(3) optionally substituted alkenyl,
(4) optionally substituted alkynyl,
where the substituents on the alkyl, alkenyl, and alkynyl are 1 to 3 groups independently selected from
(i) methyl,
(ii) X-methyl, where X is O or S(O)ₘ and
(iii) halogen,
(5) arylalkyl wherein said aryl is optionally substituted with 1 to 3 groups independently selected from R^{f}.
(6) trifluoromethyl
R₈ is (1) H,
(2) OH, or
(3) NH₂
R^{g} is (1) H, or
(2) OH;
R₁₀ is (1) C(O)OR^{b},
(2) C(O)N(OR^{b})R^{c},
(3) C(O)NR^{c}R^{d},
(4) NHC(O)OR^{b},
(5) NHC(O)NR^{c}R^{d},
(6) CH₂OR^{a},
(7) CH₂OCO₂R^{b},
(8) CH₂OC(O)NR^{c}R^{d},
(9) C(O)NR^{c}NR^{c}R^{d}, or
(10) C(O)NR^{c}SO₂R^{b};
R^{a} is (1) hydrogen,
(2) optionally substituted alkyl,
(3) optionally substituted alkenyl,
(4) optionally substituted alkynyl,
(5) optionally substituted alkanoyl,
(6) optionally substituted aroyl,
(7) optionally substituted cycloalkanoyl,
(8) optionally substituted cycloalkenoyl,
(9) optionally substituted alkylsulfonyl
where the substituents on the alkyl, alkenyl, alkynyl, alkanoyl, aroyl, cycloalkanoyl, cycloalkenoyl, and alkylsulfonyl, are from 1 to 5 groups independently selected from hydroxy, alkoxy, aryl alkoxy, NR^{g}R^{h}, CO₂R^{b}, CONR^{c}R^{d} and halogen,
(10) trifluoromethyl,
(11) arylsulfonyl optionally substituted with 1 to 3 groups independently selected from methyl, trifluoromethyl and halogen,
(12) a 5- or 6-member heterocycle containing 1 to 4 heteroatoms selected from oxygen, sulfur and nitrogen optionally substituted by 1 to 4 groups independently selected from methyl, trifluoromethyl, C(O)NR^{c}R^{d}, CO₂R^{b} and halogen, and which may be saturated or partly unsaturated;
R^{b} is (1) H,
(2) optionally substituted aryl,
(3) optionally substituted alkyl,
(4) optionally substituted alkenyl,
(5) optionally substituted alkynyl,
(6) optionally substituted cycloalkyl,
(7) optionally substituted cycloalkenyl, or
(8) optionally substituted 5- to 6-member heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups independently selected from
(i) hydroxy,
(ii) alkyl,
(iii) oxo,
(iv) SO₂NR^{g}R^{h},
(v) arylalkoxy,
(vi) hydroxyalkyl,
(vii) alkoxy,
(viii) hydroxyalkoxy,
(ix) aminoalkoxy,
(x) cyano,
(xi) alkyl-S(O)ₘ,
(xii) cycloalkyl optionally substituted
with 1 to 4 groups independently selected from R^{e},
(xiii) cycloalkenyl,
(xiv) halogen,
(xv) alkanoyloxy,
(xvi) C(O)NR^{g}R^{h},
(xvii) CO₂Rⁱ,
(xvii) —NR^{g}R^{h},
(xix) 5 to 6-member heterocycle, which may be saturated or partially unsaturated, containing from 1 to 4 heteroatoms independently selected from oxygen, sulfur and nitrogen, and optionally substituted with 1 to 5 groups independently selected from R^{e},
(xx) optionally substituted aryl, wherein the aryl substituents are 1,2-methylenedioxy or 1 to 5 groups independently selected from R^{e},
(xxi) optionally substituted aryl alkoxy, wherein the aryl substituents are 1,2-methylenedioxy or 1 to 5 groups independently selected from R^{e}, and
(xxii) perfluoroalkyl;
R^{e} is (1) halogen,
(2) alkyl,
(3) perfluoroalkyl,
(4) —S(O)ₘRⁱ,
(5) cyano,
(6) RⁱO(CH₂)ᵥ—,
(7) RⁱCO₂(CH₂)^{v}—,
(8) RⁱOCO(CH₂)ᵥ—,
(9) optionally substituted aryl where the substituents are from 1 to 3 of halogen, alkyl, alkoxy, or hydroxy,
(10) SO₂NR^{g}R^{h}, or
(11) amino;
R^{f} is (1) methyl,
(2) X-alkyl, where X is O or S(O)ₘ,
(3) trifluoromethyl,
(4) NY¹Y², where Y¹ and Y² are independently H or methyl,
(5) hydroxy,
(6) halogen, and
(7) acetylamino,
R^{g} and R^{h} are independently
(1) hydrogen,
(2) alkyl optionally substituted with hydroxy, amino, or CO₂Rⁱ
(3) aryl optionally substituted with halogen, 1,2-methylenedioxy, alkoxy, alkyl or perfluoroalkyl,
(4) aryl or arylalkyl, wherein the aryl is optionally substituted with perfluorolkyl or 1,2-methylenedioxy;
(5) alkoxycarbonyl,
(6) alkanoyl,
(7) alkanoylalkyl,
(9) arylalkoxycarbonyl,
(10) aminocarbonyl,
(11) monoalkylaminocarbonyl
(12) dialkylaminocarbonyl; or
R^{g} and R^{h} together with the N to which they are attached form a 5- to 6-member ring containing 0 to 2 additional heteroatoms selected from O, S(O)ₘ, and N, optionally substituted with 1 to 3 groups independently selected from R^{e} and oxo;
Rⁱ is (1) hydrogen,
(2) perfluoroalkyl,
(3) alkyl,
(4) optionally substituted aryl or arylalkyl, where the aryl substituents are from 1 to 3 groups independently selected from halogen, alkyl, alkoxy, and hydroxy.

5. The spot-on formulation according to claim 2, wherein
R₁₀ is C(O)NR^{c}R^{d};
R^{b} is (1) hydrogen,
(2) optionally substituted aryl,
(3) optionally substituted alkyl,
(4) optionally substituted alkenyl,
(5) optionally substituted alkynyl,
(6) optionally substituted cycloalkyl,
(7) optionally substituted cycloalkenyl, or
(8) optionally substituted 5 to 6-member heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups independently selected from the group consisting of
(i) hydroxy,
(ii) alkyl,
(iii) oxo,
(iv) SO₂NR^{g}R^{h},
(v) arylalkyl,
(vi) hydroxyalkylfoxy,
(viii) hydroxyalkoxy,
(ix) aminoalkoxy,
(x) cyano,
(xi) perfluoroalkyl,
(xii) alkyl-S(O)^{m},
(xiii) cycloalkyl optionally substituted with 1 to 4 groups selected from R^{e},
(xiv) cycloalkenyl,
(xv) halogen,
(xvi) C(O)NR^{g}R^{h},
(xvii) CO₂Rⁱ,
(xviii) —NR^{g}R^{h},
(xix) 5 to 9-member heterocycle containing from 1 to 4 heteroatoms independently selected from oxygen, sulfur and nitrogen, and optionally substituted with 1 to 3 groups independently selected from R^{e},
(xx) optionally substituted aryl, wherein the aryl substituents are 1,2-methylenedioxy or 1 to 5 groups independently selected from R^{e} and
(xxi) optionally substituted aryl alkoxy, wherein the aryl substituents are 1,2-methylenedioxy or 1 to 5 groups independently selected from R^{e};
R^{c} and R^{d} are independently selected from R^{b}; or
R^{c} and R^{d} together with the N to which they are attached form a 3- to 10-member ring containing 0 to 2 additional heteratoms selected from O, S(O)ₘ, and N, optionally substituted with 1 to 3 groups independently selected from R^{g}, hydroxy, thioxo and oxo;
R^{e} is (1) halogen,
(2) alkyl,
(3) perfluoroalkyl,
(4) RⁱO(CH₂)^{v}—,
(5) RⁱCO₂(CH₂)^{v}—,
(6) RⁱOCO(CH₂)ᵥ—,
(7) SO₂NR^{g}R^{h};
(8) amino
v is 0;
R^{g} and R^{h} are independently
(1) hydrogen,
(2) alkyl optionally substituted with hydroxy, amino, or CO₂Rⁱ,
(3) aryl optionally substituted with halogen, 1,2-methylenedioxy, alkoxy, alkyl or perfluoroalkyl,
(4) aryl or arylalkyl, wherein the aryl is optionally substituted with perfluoroalkyl or 1,2-methylenedioxy,
(5) alkoxycarbonyl,
(6) alkanoyl,
(7) arylalkoxycarbonyl,
(8) aminocarbonyl, or
R^{g} and R^{h} together with the N to which they are attached form a 5- to 6-member ring containing 0 to 2 additional heteroatoms selected from O, S(O)ₘ, and N, optionally substituted with 1 to 3 groups independently selected from R^{e} and oxo;
Rⁱ is (1) hydrogen or
(2) optionally substituted alkyl wherein the substituents are aryl or substituted aryl, and the aryl substituents are from 1 to 3 groups independently selected from halogen, alkyl, alkoxy, and hydroxy.

6. The spot-on formulation according to claim 2, wherein the nodulisporic acid derivative is a compound of the formula 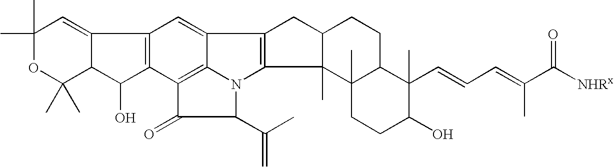
wherein R^{x} is selected from the group consisting of:
H, CH₃, CH₂CH₃, C(CH₃)₃, CH₂CH₂CH₃, CH₂CH₂OH, CH(CO₂CH₃)CH₂OH, CH₂CO₂CH₃, CH₂CH(OCH₂CH₃)₂, CH₂CH₂OCH₂CH₂OH, CH(CH₃)(CH₂)₃C(CH₃)₂OH, (CH₂)₃OH, (CH₂)₄OH, (CH₂)SOH, CH(CH₂OH)CH₂CH₃, NHC(CH₃)₃, CH₂CN, (CH₂)₆OH, CH₂CH(OH)CH₃, CH(CH₂OH)CH₂CH₂CH₃, CH₂CH₂SCH₃, CH₂CH₂SCH₂CH₃, CH₂CONH₂, CH(CH₃)(CH₂OH)₂, CH₂CH₂NHCH₂CH₂OH, CH(CH₂OH)(CH₂)₃CH₃, CH(CH₂OCH₃)CH₃, (CH₂)₂SH, (CH₂)₄NH₂, CH₂CH₂SO₂CH₃, CH₂CH₂S(O)CH₃, CH(CH(CH₃)₂)CH₂OH, (CH₂)₃NH₂, (CH₂)₃N(CH₂CH₃)₂, (CH₂)₃N(CH₃)₂, OCH₂CH₃, CH₂CH(OH)CH₂OH, OCH₃, CH₂CH₂OCH₃, CH₂CH₂NHC(O)CH₃, C(CH₃)₂CH₂OH, c-C₃H₅, cC₆H₁₁, (CH₂)₃OCH₂CH₃, CH₂CH═CH₂, C(CH₂CH₃)(CH₂OH)₂, CH₂C≡CH, CH₂CO₂CH₂CH₃, CH₂CH₂F, (CH₂)₃O(CH₂)₁₁CH₃, CH₂CH₂N(CH₃)₂, CH₂CH₂OCH₂CH₂NH₂, CH₂CF₃, NHCH₂CO₂CH₂CH₃, CH(CH₃)CO₂CH₃, C(CH₃)₂CH₂C(O)CH₃, CH(CO₂CH₂CH₃)₂, CH₂CH₃, CH(CH₂CH₂CH₃)CO₂CH₃, CH₂CH₂CH₂OCH₃, C(CH₃)₂CH₂C≡CH, (CH₂)₄CH₃, CH(CH₂CH₂CH₃)₂, (CH₂)SCH₃, CH₂CH₂CO₂H, CH(CH(CH₃)₂)CO₂CH₃, OCH₂CO₂H, CH(CH(CH₃)₂)CH₂OH, CH(CH(CH₃)₂)CH₂OH, CH(CH₃)CH₂OH, CH(CH₃)CH₂OH, CH(CH₃)₂, (CH₂)CH(CH₃)₂, CH(CH₃)CH₂CH₃, CH₂CH(CH₃)OH, (CH₂)₃CH₃, (CH₂)₂OCH₂CH₃, 1-adamantyl, (CH₂)₈CH₃, CH(CH₃)CH(CH₃)₂, (CH₂)₃NHCH₃, (CH₂)₂N(CH₂CH₃)₂,

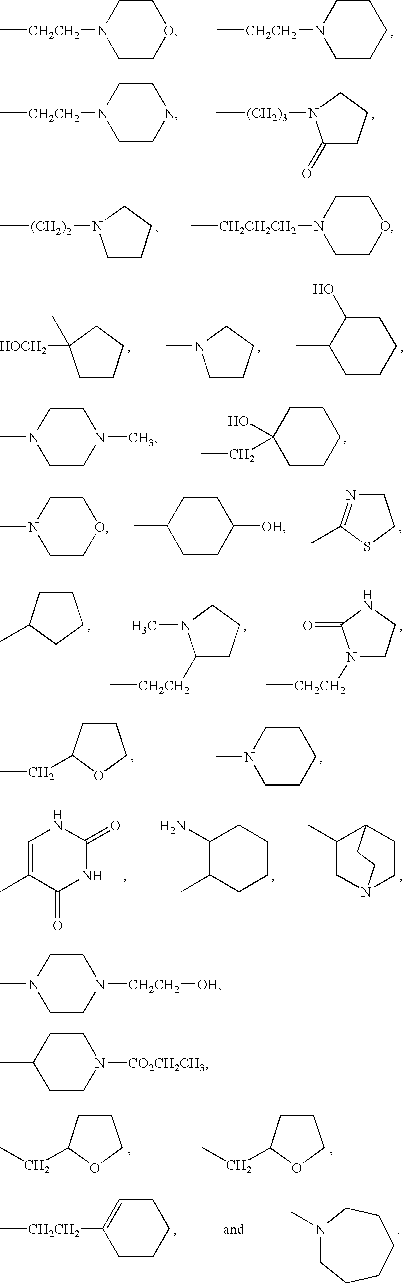

7. The spot-on formulation according to claim 6, wherein R^{x} is C(CH₃)₃.

8. The spot-on formulation according to claim 1, wherein the liquid carrier vehicle comprises a microemulsion.

9. The spot-on formulation according to claim 6, wherein the liquid carrier vehicle further comprises an excipient.

10. The spot-on formulation according to claim 9, wherein the excipient is C₈-C₁₀ caprylic/capric triglycerides, oleic acid or propylene glycol.

11. The spot-on formulation according to claim 10, wherein the spot-on formulation further comprises an antioxidant.

12. The spot-on formulation according to claim 11, wherein the antioxidant is selected from the group consisting of butylated hydroxyanisole, butylated hydroxytoluene, ascorbic acid, sodium metabisulphite, propyl gallate, and sodium thiosulphate.

13. The spot-on formulation according to claim 12, wherein the compound of formula (I) is t-butyl nodulisporamide, the carrier medium comprises diethylene glycol monoethyl ether and C₈-C₁₀ caprylic/capric triglycerides, and the antioxidant is butylated hydroxytoluene.

14. The spot-on formulation according to claim 2, wherein the combination comprises about 0.001 to about 100 mg/kg of weight of mammal or bird of a compound of formula (I).

15. The spot-on formulation according to claim 7, wherein the combination comprises about 1 to about 50 mg/kg of weight of mammal or bird of a compound of formula (I).

16. The spot-on formulation according to claim 2, which comprises crystallization inhibitor and further comprises an antioxidant.

17. The spot-on formulation wherein the compound of formula (I) is t-butyl nodulisporamide.

18. The spot-on formulation according to claim 16, wherein about 0.005 to about 1% (W/V) of antioxidant is present and the antioxidant is selected from the group consisting of butylated hydroxyanisole, butylated hydroxytoluene, ascorbic acid, sodium metabisulphite, propyl gallate, and sodium thiosulphate.

19. The spot-on formulation according to claim 18, wherein the crystallization inhibitor is present in an amount from about 1 to about 20% W/V.

20. The spot-on formulation according to claim 19, wherein
the anionic surfactant is alkaline stearates, sodium abietate; alkyl sulphates; sodium dodecylbenzenesulphonate, sodium dioctylsulphosuccinate; and fatty acids;
the cationic surfactant is water-soluble quaternary ammonium salts of formula N⁺R′R″R′″R″″ Y⁻ in which the radicals R independently are hydrocarbon radicals, optionally hydroxylated, and Y⁻ is an anion of a strong acid;
the amine salt is an amine salt of N⁺R′R″R′″ in which the radicals R independently are optionally hydroxylated hydrocarbon radicals;
the non-ionic surfactant is optionally polyoxyethylenated sorbitan esters, polyoxyethylenated alkyl ethers; polyethylene glycol stearate, polyoxyethylenated derivatives of castor oil, polyglycerol esters, polyoxyethylenated fatty alcohols, polyoxyethylenated fatty acids, copolymers of ethylene oxide and propylene oxide; and
the amphoteric surfactant is lauryl-substituted betaine compounds.

21. The spot-on formulation according to claim 19, where the crystallization inhibitor is a crystallization inhibitor system comprising a polymeric film-forming agent and a surfactant.

22. The spot-on formulation according to claim 21, wherein the polymeric film-forming agent is polyvinylpyrrolidone, polyvinyl alcohols, or a copolymer of vinyl acetate and polyvinylpyrrolidone and the surfactant is a non-ionic surfactant.

23. The spot-on formulation according to claim 22, wherein the crystallization inhibitor system is a mixture of polyvinylpyrrolidone and polyoxethylene (20) sorbitan mono-oleate.

24. The spot-on formulation according to claim 18, wherein the compound of formula (I) is t-butyl nodulisporamide, the liquid carrier vehicle is diethylene glycol monoethyl ether, the crystallization inhibitor is pyrrolidone and the antioxidant is butylated hydroxytoluene.

25. A method of treating parasite infestations or for the prophylaxis of parasite infestation in mammals, fish or birds which comprises applying to said mammals, fish or birds an effective amount of a spot-on composition according to claim 1.

26. The method according to claim 25, wherein the parasite is an ectoparasite.

27. The method according to claim 25, wherein the parasite is an endoparasite.

28. The method according to claim 25, wherein the mammal is a cat, dog, horse, cattle or sheep.

29. The method according to claim 28, wherein the parasite is a flea or tick.

30. The method according to claim 25, wherein the mammal is a human.

31. The method according to claim 25, wherein the ectoparasites are mites, ticks, mosquitoes, flies or a combination of the foregoing.

32. A method of treating parasite infestations or for the prophylaxis of parasite infestations in mammals or birds which comprises applying to said mammals or birds an effective amount of a spot-on formulation according to claim 13.

33. The method according to claim 32 wherein the parasite is a flea or tick and the mammal is a cat or dog.

34. The method of claim 25, wherein the administration is bimonthly.

35. The method of claim 25, wherein the administration is quarterly.

36. The method of claim 25, wherein the administration is monthly.

37. A method for treating parasite infestations or for the prophylaxis of parasite infestations in mammals or birds which comprises applying to said mammal or bird an effective amount of a spot-on formulation according to claim 24.

38. The method according to claim 37 wherein the mammal is a cat or dog and the parasite is a flea or tick.

39. The method of claim 37, wherein the administration is bimonthly.

40. The method of claim 37, wherein the administration is quarterly.

41. The method of claim 37, wherein the administration is monthly.

42. A spot-on formulation for combating parasites in a mammal which comprises applying a composition according to claim 6 for a localized cutaneous application to said mammal with absorption and a resultant plasma concentration of the compound(s) of formula (I) wherein the liquid carrier vehicle comprises diethylene glycol monoethyl ether, and at least one antioxidant.

43. The spot-on formulation according to claim 42 which further comprises a crystallization inhibitor.

44. The spot-on formulation as claimed in claim 43, wherein an antioxidant is BHT and the crystallization inhibitor is pyrrolidone.

45. A method for combating parasites in a mammal comprising topically administering to a mammal a parasiticically effective amount of a spot-on formulation according to claim 42.

46. The method according to claim 45, wherein the mammal is a cat or dog and the parasite is a flea or tick.

47. A method for obtaining a detectable plasma concentration of parasiticides in a mammal comprising topically applying to a localized area on said mammal a parasiticically effective amount of the spot-on formulation as claimed in claim 42.

48. A method for combating parasites of a cat or dog comprising localized cutaneous application to the cat or dog, between the shoulders, at a frequency not greater than monthly, of a spot-on composition, which comprises, in a veterinarily acceptable vehicle, an effect amount parasitically effective amount of at least one of the formula 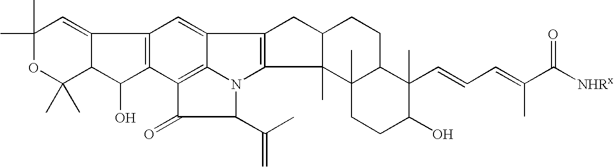
wherein R^{x} is selected from the group consisting of:
H, CH₃, CH₂CH₃, C(CH₃)₃, CH₂CH₂CH₃, CH₂CH₂OH, CH(CO₂CH₃)CH₂OH, CH₂CO₂CH₃, CH₂CH(OCH₂CH₃)₂, CH₂CH₂OCH₂CH₂OH, CH(CH₃)(CH₂)₃C(CH₃)₂OH, (CH₂)₃OH, (CH₂)₄OH, (CH₂)SOH, CH(CH₂OH)CH₂CH₃, NHC(CH₃)₃, CH₂CN, (CH₂)₆OH, CH₂CH(OH)CH₃, CH(CH₂OH)CH₂CH₂CH₃, CH₂CH₂SCH₃, CH₂CH₂SCH₂CH₃, CH₂CONH₂, CH(CH₃)(CH₂OH)₂, CH₂CH₂NHCH₂CH₂OH, CH(CH₂OH)(CH₂)₃CH₃, CH(CH₂OCH₃)CH₃, (CH₂)₂SH, (CH₂)₄NH₂, CH₂CH₂SO₂CH₃, CH₂CH₂S(O)CH₃, CH(CH(CH₃)₂)CH₂OH, (CH₂)₃NH₂, (CH₂)₃N(CH₂CH₃)₂, (CH₂)₃N(CH₃)₂, OCH₂CH₃, CH₂CH(OH)CH₂OH, OCH₃, CH₂CH₂OCH₃, CH₂CH₂NHC(O)CH₃, C(CH₃)₂CH₂OH, c-C₃H₅, cC₆H₁₁, (CH₂)₃OCH₂CH₃, CH₂CH═CH₂, C(CH₂CH₃)(CH₂OH)₂, CH₂C≡CH, CH₂CO₂CH₂CH₃, CH₂CH₂F, (CH₂)₃O(CH₂)₁₁CH₃, CH₂CH₂N(CH₃)₂, CH₂CH₂OCH₂CH₂NH₂, CH₂CF₃, NHCH₂CO₂CH₂CH₃, CH(CH₃)CO₂CH₃, C(CH₃)₂CH₂C(O)CH₃, CH(CO₂CH₂CH₃)₂, CH₂CH₃, CH(CH₂CH₂CH₃)CO₂CH₃, CH₂CH₂CH₂OCH₃, C(CH₃)₂CH₂C≡CH, (CH₂)₄CH₃, CH(CH₂CH₂CH₃)₂, (CH₂)SCH₃, CH₂CH₂CO₂H, CH(CH(CH₃)₂)CO₂CH₃, OCH₂CO₂H, CH(CH(CH₃)₂)CH₂OH, CH(CH(CH₃)₂)CH₂OH, CH(CH₃)CH₂OH, CH(CH₃)CH₂OH, CH(CH₃)₂, (CH₂)CH(CH₃)₂, CH(CH₃)CH₂CH₃, CH₂CH(CH₃)OH, (CH₂)₃CH₃, (CH₂)₂OCH₂CH₃, 1-adamantyl, (CH₂)₈CH₃, CH(CH₃)CH(CH₃)₂, (CH₂)₃NHCH₃, (CH₂)₂N(CH₂CH₃)₂,
the vehicle is for a localized cutaneous application to the animal between the shoulders and contains an organic solvent, an antioxidant and/or a crystallization inhibitor wherein:
the organic solvent comprises acetone, ethyl acetate, methanol, ethanol, isopropanol, dimethylformamide, dichloromethane or diethyl glycol monoethyl ether; said solvent optionally supplemented by Cs-C₁₀ caprylic/capric triglyceride, oleic acid or propylene glycol;
the antioxidant is selected from the group consisting of butylated hydroxyanisole, butylated hydroxytoluene, ascorbic acid, sodium metabisuphite, propylgallate, and sodium theosulphate; and
the crystallization inhibitor selected from the group consisting of polyvinylpyrrolidone, copolymers of vinyl acetate and vinylpyrrolidone, polyoxyethylenated sorbitan esters and mixtures thereof;
whereby there is a prolonged release of formula (I) in or on the body of the cat or dog.

49. The method of claim 48 wherein in the spot-on composition the compound of formula (I) is t-butyl nodulisporamide.

50. The method of claim 48 wherein compound of formula (I) is present in the spot-on composition in an amount of from about 0.1 to about 100 mg/kg of weight of animal.

51. The method according to claim 49 wherein the liquid carrier vehicle is diethylene glycol monoethyl ether and the antioxidant is butylated hydroxytoluene.

52. The method of claim 49 wherein the spot-on composition comprises an antioxidant and the antioxidant is polyvinylpyrrolidone.

53. A process for the preparation of a compound having the formula: 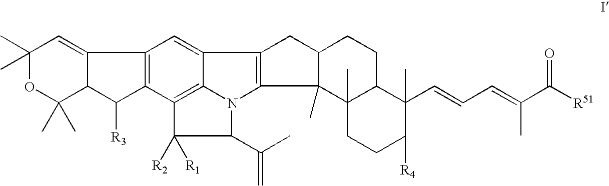
wherein
R₁ is (1) hydrogen,
(2) optionally substituted alkyl,
(3) optionally substituted alkenyl,
(4) optionally substituted alkynyl,
(5) optionally substituted cycloalkyl,
(6) optionally substituted cycloalkenyl,
where the substituents on the alkyl, alkenyl, alkynyl, cycloalkyl and cycloalkenyl are 1 to 3 groups independently selected from
(i) alkyl,
(ii) X-alkyl, where X is O or S(O)ₘ,
(iii) cycloalkyl,
(iv) hydroxy,
(v) halogen,
(vi) cyano,
(vii) carboxy,
(viii) NY¹Y², where Y¹ and Y² are independently H or alkyl,
(ix) alkanoylamino, and
(x) aroylamino wherein said aroyl is optionally substituted with 1 to 3 groups independently selected from R^{f}
(7) aryl or arylalkyl wherein said aryl is optionally substituted with 1 to 3 groups independently selected from R^{f},
(8) perfluoroalkyl
(9) a 5- or 6-member heterocycle containing from 1 to 4 heteroatoms independently selected from oxygen, sulfur and nitrogen atoms optionally substituted by 1 to 3 groups independently selected from hydroxy, oxo, alkyl and halogen, and which may be saturated or partly unsaturated,
R₂, R₃, and R₄ are independently OR^{a}, OCO₂R^{b}, OC(O)NR^{c}R^{d}; or
R₁ and R₂ represent ═O, ═NOR^{a} or ═N—NR^{c}R^{d};
R^{a} is (1) hydrogen,
(2) optionally substituted alkyl,
(3) optionally substituted alkenyl,
(4) optionally substituted alkynyl,
(5) optionally substituted alkanoyl,
(6) optionally substituted alkenoyl,
(7) optionally substituted alkynoyl,
(8) optionally substituted aroyl,
(9) optionally substituted aryl,
(10) optionally substituted cycloalkanoyl,
(11) optionally substituted cycloalkenoyl,
(12) optionally substituted alkylsulfonyl
(13) optionally substituted cycloalkyl
(14) optionally substituted cycloalkenyl
where the substituents on the alkyl, alkenyl, alkynyl, alkanoyl, alkenoyl, alkynoyl, aroyl, aryl, cycloalkanoyl, cycloalkenoyl, alkylsulfonyl, cycloalkyl and cycloalkenyl are from 1 to 10 groups independently selected from the group consisting of hydroxy, alkoxy, cycloalkyl, aryl alkoxy, NR^{g}R^{h}, CO₂R^{b}, CONR^{c}R^{d} and halogen,
(15) perfluoroalkyl,
(16) arylsulfonyl optionally substituted with 1 to 3 groups independently selected from alkyl, perfluoroalkyl, nitro, halogen and cyano,
(17) a 5- or 6-member heterocycle containing 1 to 4 heteroatoms selected from oxygen, sulfur and nitrogen optionally substituted by 1 to 4 groups independently selected from alkyl, alkenyl, perfluoroalkyl, amino, C(O)NR^{c}R^{d}, cyano, CO₂R^{b} and halogen, and which may be saturated or partly unsaturated;
R^{b} is (1) H,
(2) optionally substituted aryl,
(3) optionally substituted alkyl,
(4) optionally substituted alkenyl,
(5) optionally substituted alkynyl,
(6) optionally substituted cycloalkyl,
(7) optionally substituted cycloalkenyl, or
(8) optionally substituted heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups
independently selected from
(i) hydroxy,
(ii) alkyl,
(iii) oxo,
(iv) SO₂NR^{g}R^{h},
(v) arylalkoxy,
(vi) hydroxyalkyl,
(vii) alkoxy,
(viii) hydroxyalkoxy,
(ix) aminoalkoxy,
(x) cyano,
(xi) mercapto,
(xii) alkyl-S(O)ₘ,
(xiii) cycloalkyl optionally substituted
with 1 to 4 groups independently selected from R^{e},
(xiv) cycloalkenyl,
(xv) halogen,
(xvi) alkanoyloxy,
(xvii) C(O)NR^{g}R^{h},
(xviii) CO₂Rⁱ,
(xix) formyl,
(xx) —NR^{g}R^{h},
(xxi) 5 to 9-member heterocycle, which may be saturated or partially unsaturated, containing from 1 to 4 heteroatoms independently selected from oxygen, sulfur and nitrogen, and optionally substituted with 1 to 5 groups independently selected from R^{e},
(xxii) optionally substituted aryl, wherein the aryl substituents are 1,2-methylenedioxy or 1 to 5 groups independently selected from R^{e},
(xxiii) optionally substituted arylalkoxy,
wherein the aryl substituents are 1,2-methylenedioxy or 1 to 5 groups independently selected from R^{e}, and
(xxiv) perfluoroalkyl;
R^{c} and R^{d} are independently selected from R^{b}; or
R^{c} and R^{d} together with the N to which they are attached form a 3- to 10-member ring containing 0 to 2 additional heteroatoms selected from O, S(O)ₘ, and N, optionally substituted with 1 to 3 groups independently selected from R^{g}, hydroxy, thioxo and oxo;
R^{e} is (1) halogen,
(2) alkyl,
(3) perfluoroalkyl,
(4) —S(O)ₘRⁱ,
(5) cyano,
(6) nitro,
(7) RⁱO(CH₂)ᵥ—,
(8) RⁱCO₂(CH₂)ᵥ—,
(9) RⁱOCO(CH₂)ᵥ—,
(10) optionally substituted aryl where the substituents are from 1 to 3 of halogen, alkyl, alkoxy, or hydroxy,
(11) SO₂NR^{g}R^{h}, or
(12) amino;
R^{f} is (1) alkyl,
(2) X-alkyl, where X is O or S(O)ₘ,
(3) alkenyl,
(4) alkynyl,
(5) perfluoroalkyl,
(6) NY¹Y², where Y¹ and Y² are independently H or alkyl,
(7) hydroxy,
(8) halogen, and
(9) alkanoyl amino,
R^{g} and R^{h} are independently
(1) hydrogen,
(2) alkyl optionally substituted with hydroxy, amino, or CO₂Rⁱ
(3) aryl optionally substituted with halogen, 1,2-methylenedioxy, alkoxy, alkyl or perfluoroalkyl,
(4) arylalkyl, wherein the aryl is optionally substituted with perfluorolkyl or 1,2-methylenedioxy;
(5) alkoxycarbonyl,
(6) alkanoyl,
(7) alkanoylalkyl,
(9) arylalkoxycarbonyl,
(10) aminocarbonyl,
(11) monoalkylaminocarbonyl (12) dialkylaminocarbonyl; or
R^{g} and R^{h} together with the N to which they are attached form a 3- to 7-member ring containing 0 to 2 additional heteroatoms selected from O, S(O)ₘ, and N, optionally substituted with 1 to 3 groups independently selected from R^{e} and oxo;
Rⁱ is (1) hydrogen,
(2) perfluoroalkyl,
(3) alkyl,
(4) optionally substituted aryl, or arylalkyl, where the aryl substituents are from 1 to 3 groups independently selected from halogen, alkyl, alkoxy, and hydroxy;
m is 0 to 2; and
v is 0 to 3;
R⁵¹ is R^{c} and R^{d}
or a pharmaceutically acceptable salt thereof which comprises
(1) coupling a compound of formula II′: 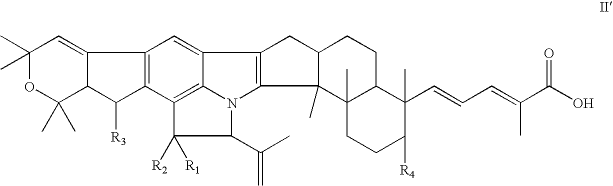
wherein
R₁, R₂, R₃, and R⁴ are defined above,
with a compound of formula III:
R^{6′}—N═C═N—R^{7′} III
wherein R^{6′} and R^{7′} can be independently selected from alkyl and cycloalkyl, in the presence of an organic solvent to produce a first intermediate compound, of the formula 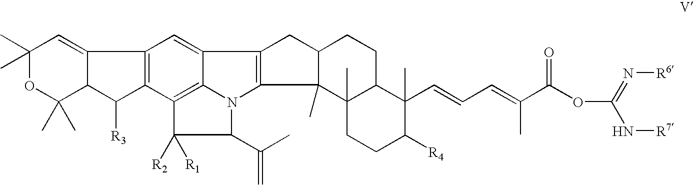
(2) reacting the first intermediate compound with an activating compound, Act
to produce a second intermediate compound of the formula: 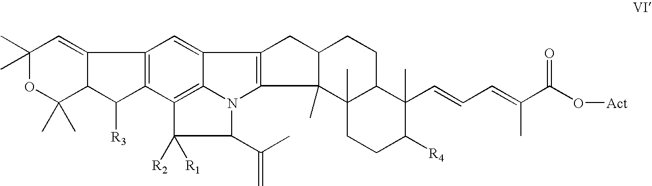
(3) adding an alkyl amine of the formula HNR^{c}R^{d} to the second intermediate compound to obtain a compound of formula I′.

54. The process according to claim 53, wherein the activating compound is 1-hydroxybenzotriazole, 2-hydroxypyridine-N-oxide, 2-hydroxypyridine and hydroxysuccinimide.

55. The process according to claim 53 wherein the first intermediate compound has the formula 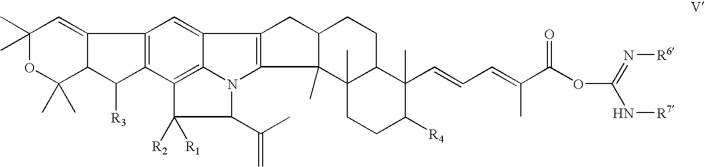
wherein R^{6′} and R^{7′} can be independently selected from alkyl and cycloalkyl, or a pharmaceutically acceptable salt thereof.

56. The process according to claim 53 wherein the second intermediate compound has the formula 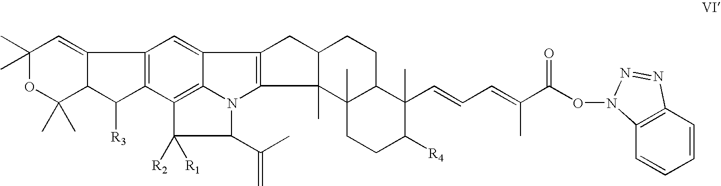
or a pharmaceutically acceptable salt thereof.

57. The process according to claim 53 wherein said organic solvent is a halogenated hydrocarbon or a mixture of halogenated hydrocarbons.

58. The process according to claim 53 wherein said organic solvent is an ether or a mixture of ethers.

59. The process according to claim 56 wherein said halogenated hydrocarbon is methlyene chloride.

60. The process according to claim 57 wherein said ether or mixture of ethers are selected from the group consisting of tetrahydrofuran, diethyl ether, and methyl t-butyl ether.

61. The process according to claim 52 wherein the process is which is carried out in a single step without the isolation of a first and second intermediate compounds.

62. The process according to claim 53 which is carried out step-wise with the isolation of a first and/or second intermediate compounds.

63. A compound of the formula: 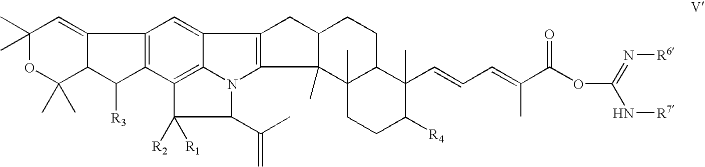
wherein
R₁ is (1) hydrogen,
(2) optionally substituted alkyl,
(3) optionally substituted alkenyl,
(4) optionally substituted alkynyl,
(5) optionally substituted cycloalkyl,
(6) optionally substituted cycloalkenyl,
where the substituents on the alkyl, alkenyl, alkynyl, cycloalkyl and cycloalkenyl are 1 to 3 groups independently selected from
(i) alkyl,
(ii) X-alkyl, where X is O or S(O)ₘ,
(iii) cycloalkyl,
(iv) hydroxy,
(v) halogen,
(vi) cyano,
(vii) carboxy,
(viii) NY¹Y², where Y¹ and Y² are independently H or alkyl,
(ix) alkanoylamino, and
(x) aroylamino wherein said aroyl is optionally substituted with 1 to 3 groups independently selected from R^{f}
(7) aryl or arylalkyl wherein said aryl is optionally substituted with 1 to 3 groups independently selected from R^{f},
(8) perfluoroalkyl
(9) a 5- or 6-member heterocycle containing from 1 to 4 heteroatoms independently selected from oxygen, sulfur and nitrogen atoms optionally substituted by 1 to 3 groups independently selected from hydroxy, oxo, alkyl and halogen, and which may be saturated or partly unsaturated,
R₂, R₃, and R⁴ are independently OR^{a}, OCO₂R^{b}, OC(O)NR^{c}R^{d}; or
R₁ and R₂ represent ═O, ═NOR^{a} or ═N—NR^{c}R^{d};
R^{a} is (1) hydrogen,
(2) optionally substituted alkyl,
(3) optionally substituted alkenyl,
(4) optionally substituted alkynyl,
(5) optionally substituted alkanoyl,
(6) optionally substituted alkenoyl,
(7) optionally substituted alkynoyl,
(8) optionally substituted aroyl,
(9) optionally substituted aryl,
(10) optionally substituted cycloalkanoyl,
(11) optionally substituted cycloalkenoyl,
(12) optionally substituted alkylsulfonyl
(13) optionally substituted cycloalkyl
(14) optionally substituted cycloalkenyl
where the substituents on the alkyl, alkenyl, alkynyl, alkanoyl, alkenoyl, alkynoyl, aroyl, aryl, cycloalkanoyl, cycloalkenoyl, alkylsulfonyl, cycloalkyl and cycloalkenyl are from 1 to 10 groups independently selected from the group consisting of hydroxy, alkoxy, cycloalkyl, aryl alkoxy, NR^{g}R^{h}, CO₂R^{b}, CONR^{c}R^{d} and halogen,
(15) perfluoroalkyl,
(16) arylsulfonyl optionally substituted with 1 to 3 groups independently selected from alkyl, perfluoroalkyl, nitro, halogen and cyano,
(17) a 5- or 6-member heterocycle containing 1 to 4 heteroatoms selected from oxygen, sulfur and nitrogen optionally substituted by 1 to 4 groups independently selected from alkyl, alkenyl, perfluoroalkyl, amino, C(O)NR^{c}R^{d}, cyano, CO₂R^{b} and halogen, and which may be saturated or partly unsaturated;
R^{b} is (1) H,
(2) optionally substituted aryl,
(3) optionally substituted alkyl,
(4) optionally substituted alkenyl,
(5) optionally substituted alkynyl,
(6) optionally substituted cycloalkyl,
(7) optionally substituted cycloalkenyl, or
(8) optionally substituted heterocycle containing from 1 to 4 heteroatoms independently selected from oxygen, sulfur and nitrogen; where the substituents on the aryl, alkyl, alkenyl, cycloalkyl, cycloalkenyl, heterocycle, or alkynyl are from 1 to 10 groups
independently selected from
(i) hydroxy,
(ii) alkyl,
(iii) oxo,
(iv) SO₂NR^{g}R^{h},
(v) arylalkoxy,
(vi) hydroxyalkyl,
(vii) alkoxy,
(viii) hydroxyalkoxy,
(ix) aminoalkoxy,
(x) cyano,
(xi) mercapto,
(xii) alkyl-S(O)ₘ,
(xiii) cycloalkyl optionally substituted with 1 to 4 groups independently selected from R^{e},
(xiv) cycloalkenyl,
(xv) halogen,
(xvi) alkanoyloxy,
(xvii) C(O)NR^{g}R^{h},
(xviii) CO₂Rⁱ,
(xix) formyl,
(xx) —NR^{g}R^{h},
(xxi) 5 to 9-member heterocycle, which may be saturated or partially unsaturated, containing from 1 to 4 heteroatoms independently selected from oxygen, sulfur and nitrogen, and optionally substituted with 1 to 5 groups independently selected from R^{e},
(xxii) optionally substituted aryl, wherein the aryl substituents are 1,2-methylenedioxy or 1 to 5 groups independently selected from R^{e},
(xxiii) optionally substituted arylalkoxy,
wherein the aryl substituents are 1,2-methylenedioxy or 1 to 5 groups independently selected from R^{e}, and
(xxiv) perfluoroalkyl;
R^{c} and R^{d} are independently selected from R^{b}; or
R^{c} and R^{d} together with the N to which they are attached form a 3- to 10-member ring containing 0 to 2 additional heteroatoms selected from O, S(O)ₘ, and N, optionally substituted with 1 to 3 groups independently selected from R^{g}, hydroxy, thioxo and oxo;
R^{e} is (1) halogen,
(2) alkyl,
(3) perfluoroalkyl,
(4) —S(O)ₘRⁱ,
(5) cyano,
(6) nitro,
(7) RⁱO(CH₂)ᵥ—,
(8) RⁱCO₂(CH₂)ᵥ—,
(9) RⁱOCO(CH₂)ᵥ—,
(10) optionally substituted aryl where the substituents are from 1 to 3 of halogen, alkyl, alkoxy, or hydroxy,
(11) SO₂NR^{g}R^{h}, or
(12) amino;
R^{f} is (1) alkyl,
(2) X-alkyl, where X is O or S(O)ₘ,
(3) alkenyl,
(4) alkynyl,
(5) perfluoroalkyl,
(6) NY¹Y², where Y¹ and Y² are independently H or alkyl,
(7) hydroxy,
(8) halogen, and
(9) alkanoyl amino,
R^{g} and R^{h} are independently
(1) hydrogen,
(2) alkyl optionally substituted with hydroxy, amino, or CO₂Rⁱ
(3) aryl optionally substituted with halogen, 1,2-methylenedioxy, alkoxy, alkyl or perfluoroalkyl,
(4) arylalkyl, wherein the aryl is optionally substituted with perfluorolkyl or 1,2-methylenedioxy;
(5) alkoxycarbonyl,
(6) alkanoyl,
(7) alkanoylalkyl,
(9) arylalkoxycarbonyl,
(10) aminocarbonyl,
(11) monoalkylaminocarbonyl
(12) dialkylaminocarbonyl; or
R^{g} and R^{h} together with the N to which they are attached form a 3- to 7-member ring containing 0 to 2 additional heteroatoms selected from O, S(O)ₘ, and N, optionally substituted with 1 to 3 groups independently selected from R^{e} and oxo;
Rⁱ is (1) hydrogen,
(2) perfluoroalkyl,
(3) alkyl,
(4) optionally substituted aryl, or arylalkyl, where the aryl substituents are from 1 to 3 groups independently selected from halogen, alkyl, alkoxy, and hydroxy;
m is 0 to 2; and
v is 0 to 3;
R^{6′} and R^{7′} can be independently selected from alkyl and cycloalkyl, or a salt thereof.
